(19) United States
(12) Patent Application Publication
(10) Pub. No.: US 2025/0254561 A1
(43) Pub. Date: Aug. 7, 2025

(54) Adapt Physical Downlink Control Channel (PDCCH) Monitoring and/or Connected Mode Discontinuous Reception (CDRX) Behavior of a User Equipment (UE) Based on a Delay Status Report (DSR)

(71) Applicant: QUALCOMM Incorporated, San Diego, CA (US)

(72) Inventors: Diana MAAMARI, San Diego, CA (US); Mickael MONDET, Louannec (FR); Linhai HE, San Diego, CA (US); Huilin XU, Temecula, CA (US); Prasad Reddy KADIRI, San Diego, CA (US)

(21) Appl. No.: 18/430,438

(22) Filed: Feb. 1, 2024

(51) Int. Cl. H04W 28/02; H04W 76/28

(52) U.S. Cl. CPC H04W 28/0278; H04W 28/0236; H04W 76/28

(57) ABSTRACT

Certain aspects of the present disclosure provide techniques for physical downlink control channel (PDCCH) monitoring and/or connected mode discontinuous reception (CDRX) adaptation. A method generally includes transmitting, to a network entity, a delay status report (DSR) comprising: one or more fields indicating whether or not delay information is present in the DSR for one or more logical channel groups (LCGs); and delay information for at least one LCG of the one or more LCGs for which the one or more fields indicate delay information is present in the DSR, the at least one LCG comprising a first LCG; and based on transmission of the DSR, perform a first action comprising to at least one of: monitoring at least one PDCCH monitoring occasion of one or more PDCCH monitoring occasions that the apparatus was previously indicated to stop monitoring; or exiting a CDRX inactive state.

### INTRODUCTION

### Field of the Disclosure

Aspects of the present disclosure relate to wireless communications, and more particularly, to techniques for physical downlink control channel (PDCCH) monitoring and/or connected mode discontinuous reception (CDRX) adaptation.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communications by an apparatus. The method includes transmitting, to a network entity, a delay status report (DSR) comprising: one or more fields indicating whether or not delay information is present in the DSR for one or more logical channel groups (LCGs); and delay information for at least one LCG of the one or more LCGs for which the one or more fields indicate delay information is present in the DSR, the at least one LCG comprising a first LCG; and performing, based on transmission of the DSR, a first action comprising to at least one of: monitor at least one physical downlink control channel (PDCCH) monitoring occasion of one or more PDCCH monitoring occasions that the apparatus was previously indicated to stop monitoring; or exit a discontinuous reception (CDRX) inactive state.

Another aspect provides a method for wireless communications by an apparatus. The method includes receiving, from a user equipment (UE), a DSR comprising: one or more fields indicating whether or not delay information is present in the DSR for one or more LCGs; and delay information for at least one LCG of the one or more LCGs for which the one or more fields indicate delay information is present in the DSR, the at least one LCG comprising a first LCG; and based on reception of the DSR, transmitting, to the UE, an indication to perform a first action comprising to at least one of: monitor at least one PDCCH monitoring occasion of one or more PDCCH monitoring occasions that the UE was previously indicated to stop monitoring; or exit a CDRX inactive state.

Other aspects provide: one or more apparatuses operable, configured, or otherwise adapted to perform any portion of any method described herein (e.g., such that performance may be by only one apparatus or in a distributed fashion across multiple apparatuses); one or more non-transitory, computer-readable media comprising instructions that, when executed by one or more processors of one or more apparatuses, cause the one or more apparatuses to perform any portion of any method described herein (e.g., such that instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors, and/or such that performance may be by only one apparatus or in a distributed fashion across multiple apparatuses); one or more computer program products embodied on one or more computer-readable storage media comprising code for performing any portion of any method described herein (e.g., such that code may be stored in only one computer-readable medium or across computer-readable media in a distributed fashion); and/or one or more apparatuses comprising one or more means for performing any portion of any method described herein (e.g., such that performance would be by only one apparatus or by multiple apparatuses in a distributed fashion). By way of example, an apparatus may comprise a processing system, a device with a processing system, or processing systems cooperating over one or more networks. An apparatus may comprise one or more memories; and one or more processors configured to cause the apparatus to perform any portion of any method described herein. In some examples, one or more of the processors may be preconfigured to perform various functions or operations described herein without requiring configuration by software.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment (UE).

FIGS. 4A, 4B, 4C, and 4D depict various example aspects of data structures for a wireless communications network.

FIG. 5 depicts example physical downlink control channel (PDCCH) monitoring behavior of a UE adapted to stop monitoring PDCCH monitoring occasions that the UE was previously scheduled to monitor.

FIGS. 6A and 6B depict the impact adapting PDCCH monitoring behavior has on latency and power savings at a UE.

FIG. 7 depicts example adapted PDCCH monitoring behavior of a UE after sending a scheduling request (SR).

FIG. 8 depicts example remaining time delay budget associated with a logical channel group (LCG) that may be included in a delay status report (DSR).

FIG. 9A depicts example adapted PDCCH monitoring behavior of a UE after sending a DSR.

FIG. 9B depicts an example DSR.

FIG. 10 depicts example DSR transmission based on a configured reporting threshold.

FIG. 11 depicts a method for wireless communications.

FIG. 12 depicts a method for wireless communications.

FIG. 13 depicts aspects of an example communications device.

FIG. 14 depicts aspects of an example communications device.

### DETAILED DESCRIPTION

Aspects of the present disclosure provide apparatuses, methods, processing systems, and computer-readable mediums for adapting physical downlink control channel (PDCCH) monitoring behavior and/or connected mode discontinuous reception (CDRX) behavior, of a UE, based on a delay status report (DSR).

For example, a UE may be configured to monitor one or more PDCCH monitoring occasions (e.g., specific time intervals during which the UE is expected to monitor the PDCCH) to obtain scheduling information, such as downlink control information (DCI), for a given downlink channel or uplink channel. Requiring a UE to continuously monitor PDCCH monitoring occasions for DCI is a contributor to power consumption at the UE. As such, in certain aspects, a PDCCH monitoring adaptation indication (also simply referred to herein as an “adaptation indication”) may be used to trigger a UE to stop monitoring PDCCH monitoring occasion(s) that the UE was previously scheduled to monitor.

In some cases, the adaptation indication may include a PDCCH skipping command instructing a receiving UE (e.g., of the adaptation indication) to skip PDCCH monitoring for a specific duration. In other words, an indication including a PDCCH skipping command may instruct the UE to stop monitoring PDCCH monitoring occasions that are scheduled during the indicated time period. In some cases, the adaptation indication may include a search space set group (SSSG) switching command indicating that a receiving UE (e.g., of the adaptation indication) is to switch from monitoring a first SSSG to monitoring a second SSSG indicated in the PDCCH monitoring adaptation indication. An SSSG includes one or more search space sets (SSSs). For example, a UE may be configured to monitor a first SSS included in a first SSSG (e.g., along with one or more other SSSs). An SSSG switching indication received by the UE may indicate to switch from monitoring the first SSSG to monitoring the second SSSG, where the second SSSG does not include the first SSS. As such, in response to receiving the adaptation indication, the UE may stop monitoring PDCCH monitoring occasions associated with the first SSS, and correspondingly the first SSSG. In some cases, such SSSG switching is used to cause the UE to monitor less PDCCH monitoring occasions by switching from an SSSG associated with denser PDCCH monitoring occasions (e.g., a larger amount of occasions with smaller periodicity) to an SSSG associated with sparser PDCCH monitoring occasions (e.g., a smaller amount of occasions with larger periodicity). Accordingly, using either adaptation indication, a UE may monitor for less PDCCH monitoring occasion(s) than the UE was originally scheduled to monitor, thereby reducing power consumption at the UE. However, often times, such power savings are achieved at the expense of other parameters considered in a wireless communications system, such as latency, reliability, and/or throughput.

For example, there may be a tradeoff between power savings at a UE and latency achieved for communications between the UE and a network entity. Specifically, stopping monitoring one or more PDCCH monitoring occasion(s) previously scheduled for the UE after receiving an adaptation indication (e.g., indicating PDCCH skipping and/or SSSG switching) may result in increased power savings at the UE but at the cost of increased latency in communication due to increased delays in receiving re-transmitted data units from a network entity, receiving grant(s) to transmit uplink data to a network entity, etc. While in some cases reducing power consumption at the UE may be a higher priority than reducing latency in communication between the UE and the network entity, in some other cases, the opposite may be true. In other words, reduced power savings at the UE may be more tolerable than increased latency, thus, in some implementations, a mechanism for overriding a PDCCH monitoring adaptation received at the UE is introduced. Overriding a PDCCH monitoring adaptation indication may include terminating PDCCH skipping and/or SSSG switching triggered by the adaptation indication and monitoring at least one PDCCH monitoring occasion the UE was instructed to stop monitoring.

In some cases, a UE determines to override a previously-received PDCCH monitoring adaptation indication based on the transmission of a negative acknowledgement (NACK) for a previous downlink transmission. The UE may transmit a NACK when it is unable to successfully receive and decode the previous downlink transmission. In some cases, an entity (e.g., network entity), upon receiving a NACK for the downlink transmission, may resend the downlink transmission. In particular, a UE may again begin monitoring PDCCH monitoring occasion(s) that a previously-received PDCCH monitoring adaptation indication indicated to stop monitoring after transmitting a NACK for a previous downlink transmission. Terminating the PDCCH skipping after transmitting a NACK for a previous downlink transmission may allow the UE to receive one or more data re-transmissions for the previous downlink transmission without delay (e.g., without having to wait until a period of time specified in the adaptation indication, for which the UE is to stop monitoring previously scheduled monitoring occasion(s), has passed to monitor for PDCCH scheduling the data re-transmission(s)).

In some cases, a UE determines to override a previously-received PDCCH monitoring adaptation indication, indicating to perform PDCCH skipping, based on transmitting a scheduling request (SR). An SR is a physical layer message sent by the UE to the network entity to request an uplink grant to send uplink data over a PUSCH. A UE may send an SR to terminate the PDCCH skipping and/or SSSG switching triggered by a previously-received adaptation indication to reduce uplink scheduling latency that may have been increased due to an inability of the UE to monitor for PDCCH and thus receive an uplink grant used to transmit uplink data from the UE to the network entity (e.g., while in a low power state and not monitoring PDCCH monitoring occasion(s) based on the adaptation indication).

A technical problem associated with using a NACK transmission alone to override a PDCCH monitoring adaptation indication is that use of this mechanism is limited to only cases where a downlink transmission has not been received at the UE. This mechanism may not allow the UE to override the adaptation indication to, for example, reduce communication latency in other scenarios.

A technical challenge associated with using an SR to override a previously-received PDCCH monitoring adaptation indication includes determining when to transmit the SR. In particular, a UE may transmit an SR at any time without considering factors such as (1) desired levels of power consumption at the UE, (2) desired latency, (3) configured packet delay budgets, (4) an amount of data buffered at the UE, and/or the like. Accordingly, a mechanism that takes such factors into consideration when triggering the termination of action(s) triggered by a previously-received PDCCH monitoring adaptation indication may be desired to help improve wireless communications between the network entity and the UE and/or power consumption at the UE.

Aspects described herein overcome the aforementioned technical problems/challenges and improve upon the state of the art by providing techniques for adapting PDCCH monitoring at a UE based on a DSR. Adapting the PDCCH monitoring behavior may include a UE monitoring at least one PDCCH monitoring occasion that the UE was previously instructed to stop monitoring via a PDCCH monitoring adaptation indication after transmitting a DSR to a network entity. Thus, in certain aspects, adapting the PDCCH monitoring behavior may include transmitting a DSR to a network entity to override a previously-communicated PDCCH monitoring adaptation indication indicating to stop monitoring PDCCH monitoring occasion(s) scheduled for the UE.

As used herein, a DSR is a message (e.g., medium access control element (MAC-CE)) transmitted by a UE to provide a network entity (e.g., a base station (BS) associated with a serving cell of the UE) with information about one or more logical channel groups (LCGs), where each LCG includes one or more logical channels. A logical channel may be a point-to-point bi-directional channel used to communicate information and/or data between the UE and a network entity. In certain aspects, the information associated with an LCG and included in the DSR may include information about a smallest remaining packet delay budget (e.g., shortest time period) associated with one or more data units buffered for the LCG, where a packet delay budget defines a maximum amount of time that a packet may be delayed when communicated between the UE and the network entity, and a remaining packet delay budget for a packet indicates an amount of time delay remaining of the maximum amount of time for the packet (e.g., the difference between the maximum amount of time and the amount of time the packet has already been delayed). For example, to meet a quality of service (QOS) requirement, all data units associated with a packet and transmitted to the UE may need to be received at the UE within the defined the packet delay budget. A remaining packet delay budget may indicate an amount of time remaining for transmitting data units associated with the packet within this defined time period. Further, in certain aspects, the information associated with an LCG and included in the DSR may include information about an amount of data currently buffered at the UE for the corresponding LCG.

In certain aspects, to limit the override of a previously-received PDCCH monitoring adaptation indication based at least on transmission of a DSR, one or more conditions may be used by the UE for determining whether to override the previously-received PDCCH monitoring adaptation indication.

For example, in certain aspects, one or more conditions may be used to determine whether the UE transmits the DSR, thereby limiting override of the previously-received PDCCH monitoring adaptation indication in response to transmission of the DSR when the one or more conditions are met. For example, in certain aspects, a condition is whether a remaining packet delay budget associated with the LCG is less than or equal to a reporting threshold (e.g., where the reporting threshold is measured from an expiration time for a discard timer set to a value of the packet delay budget). Accordingly, in certain aspects, when the remaining packet delay budget associated with the LCG is less than or equal to the reporting threshold, the UE transmits a DSR and the UE overrides the previously-received PDCCH monitoring adaptation indication.

In certain aspects, a condition is that the UE, in addition to transmitting a DSR, prior to transmitting the DSR, transmit a NACK for one or more data units intended for the UE, to override a PDCCH monitoring adaptation indication.

In certain aspects, a condition is that the UE transmits a DSR including a buffer size information for at least one LCG, where the buffer size information indicates an amount of data buffered for the at least one LCG that is greater than a threshold, to override a PDCCH monitoring adaptation indication.

In certain aspects, a condition is that the UE transmits a DSR including information for at least one high priority LCG (e.g., LCG having a priority greater than a threshold priority), the information indicating an amount of data buffered for the at least one LCG that is greater than a threshold, to override a PDCCH monitoring adaptation indication.

Further, in certain aspects, a condition is that the UE, in response to transmitting a DSR to a network entity, receive an indication from the network entity, indicating to monitor at least one PDCCH monitoring occasion the UE was previously indicated to stop monitoring. For example, overriding a PDCCH monitoring adaptation indication may occur where a network entity receiving the DSR has approved the UE to terminate PDCCH skipping and/or SSSG switching, which the UE was previously indicated to perform.

In certain aspects, certain techniques described herein for adapting PDCCH monitoring behavior of a UE (e.g., overriding a PDCCH monitoring adaptation indication) based on a DSR may help to provide a more comprehensive view into whether a UE may benefit from remaining in a low power state, in accordance with a previously-communicated PDCCH monitoring adaptation indication, or override the adaptation indication and resume PDCCH monitoring. For example, a DSR including information about a large remaining packet delay budget (e.g., greater than a threshold) associated with one or more data units buffered for an LCG (and associated with a packet) may indicate that transmission delay(s) for the remaining data unit(s) associated with the packet are tolerable. Thus, the UE may remain in a lower power mode and not monitor PDCCH monitoring occasion(s), in accordance with the previously-communicated adaptation indication (e.g., to help optimize power). On the other hand, a DSR including information about a small remaining packet delay budget (e.g., smaller than a threshold) associated with one or more data units buffered for an LCG (and associated with a packet) may indicate that transmission delay(s) for the remaining data unit(s) are not tolerable (e.g., are critical). Thus, overriding the previously-communicated PDCCH monitoring adaptation indication may be beneficial to help optimize latency and avoid the data buffering at the UE from becoming obsolete.

Further, use of a DSR to adapt PDCCH monitoring behavior at a UE, and more specifically override a PDCCH monitoring adaptation indication, may provide some other advantages over use of an SR in some implementations to perform similar functions. For example, a DSR may provide additional granularity that may not be provided when using an SR. For example, a DSR may provide information about (1) a remaining packet delay budget and/or (2) an amount of buffered information for a single LCG, while an SR may not provide this level of granularity. Information associated with a single logical channel, as opposed to information associated with multiple logical channels, may allow a network entity receiving the DSR to better understand the delays experienced during communication between the UE and the network entity. Further, resources (e.g., configured grant resources) for transmitting a DSR may be more readily available than resources (e.g., physical uplink shared channel (PUSCH) resources) used to transmit an SR. Accordingly, a UE may be provided with more opportunities for overriding a PDCCH monitoring adaptation indication, where necessary, to help reduce latency and thereby improve overall communications between the UE and a network entity.

In some cases, in addition to, or alternative to, using a DSR to adapt the PDCCH monitoring behavior of a UE (e.g., signal adapting of the PDCCH monitoring behavior of the UE), the DSR may be used to adapt connected mode discontinuous reception (CDRX) behavior of a UE (e.g., signal adapting of CDRX behavior of the UE). For example, CDRX is a technique used to preserve battery at a UE while there is no user traffic and the UE is in a radio resource control (RRC) connected state (also referred to as a “connected state,” “a connected mode,” “an RRC connected mode,” etc.) (e.g., the UE has an established RRC connection with a network entity). If CDRX is enabled for a UE, the UE, while in an RRC connected state, may remain in a low power, sleep state (e.g., during a DRX OFF duration, where no transmission and/or reception occurs) and only wake up periodically (e.g., during DRX ON durations) for a short interval of time to monitor for scheduled, downlink data. Adapting the CDRX behavior of a UE based on transmitting a DSR may include transitioning from a CDRX inactive mode to a CDRX active mode to transmit to and/or receive data from a network entity.

### Introduction to Wireless Communications Networks

The techniques and methods described herein may be used for various wireless communications networks. While aspects may be described herein using terminology commonly associated with 3G, 4G, 5G, 6G, and/or other generations of wireless technologies, aspects of the present disclosure may likewise be applicable to other communications systems and standards not explicitly mentioned herein.

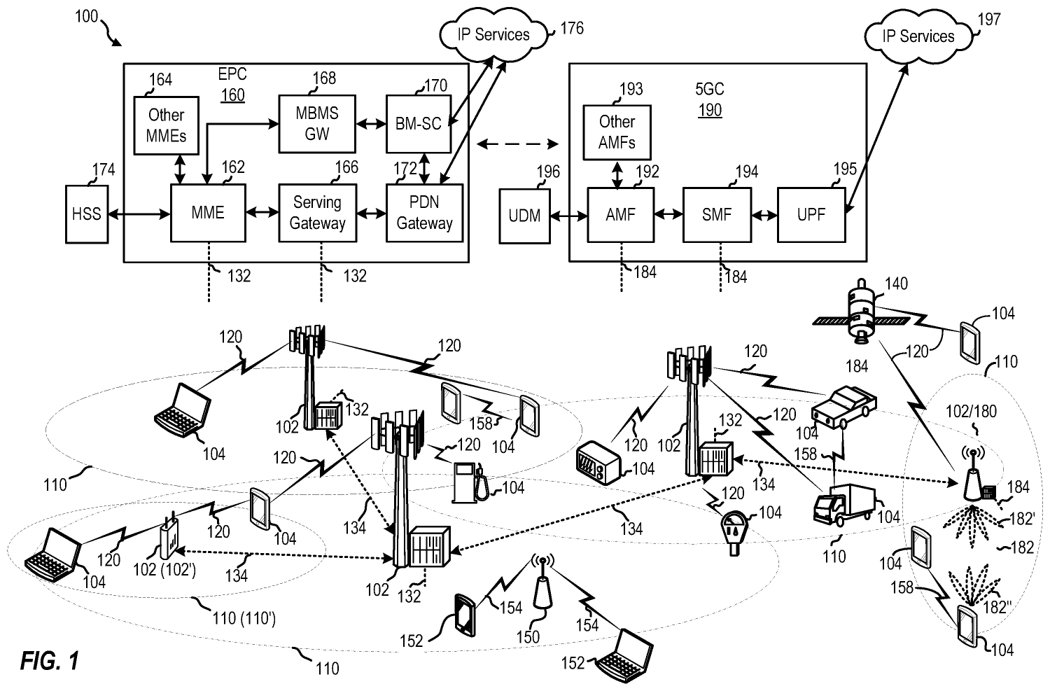

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). As such communications devices are part of wireless communications network 100, and facilitate wireless communications, such communications devices may be referred to as wireless communications devices. For example, various functions of a network as well as various devices associated with and interacting with a network may be considered network entities. Further, wireless communications network 100 includes terrestrial aspects, such as ground-based network entities (e.g., BSs 102), and non-terrestrial aspects (also referred to herein as non-terrestrial network entities), such as satellite 140 and transporter, which may include network entities on-board (e.g., one or more BSs) capable of communicating with other network elements (e.g., terrestrial BSs) and UEs.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, data centers, or other similar devices. UEs 104 may also be referred to more generally as a mobile device, a wireless device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-NB), next generation NodeB (gNB or gNodeB), access point, base transceiver station, radio base station, radio transceiver, transceiver function, transmission reception point, and/or others. Each of BSs 102 may provide communications coverage for a respective coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

Generally, a cell may refer to a portion, partition, or segment of wireless communication coverage served by a network entity within a wireless communication network. A cell may have geographic characteristics, such as a geographic coverage area, as well as radio frequency characteristics, such as time and/or frequency resources dedicated to the cell. For example, a specific geographic coverage area may be covered by multiple cells employing different frequency resources (e.g., bandwidth parts) and/or different time resources. As another example, a specific geographic coverage area may be covered by a single cell. In some contexts (e.g., a carrier aggregation scenario and/or multi-connectivity scenario), the terms “cell” or “serving cell” may refer to or correspond to a specific carrier frequency (e.g., a component carrier) used for wireless communications, and a “cell group” may refer to or correspond to multiple carriers used for wireless communications. As examples, in a carrier aggregation scenario, a UE may communicate on multiple component carriers corresponding to multiple (serving) cells in the same cell group, and in a multi-connectivity (e.g., dual connectivity) scenario, a UE may communicate on multiple component carriers corresponding to multiple cell groups.

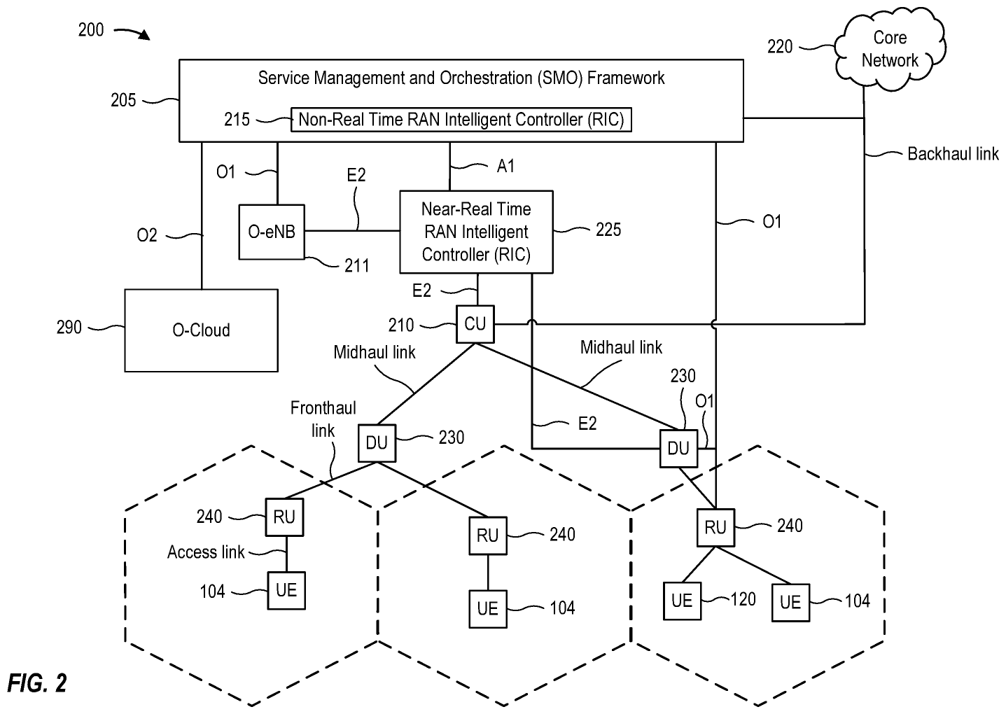

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHZ-7125 MHz, which is often referred to (interchangeably) as “Sub-6 GHz”. Similarly, 3GPP currently defines Frequency Range 2 (FR2) as including 24,250 MHZ-71,000 MHZ, which is sometimes referred to (interchangeably) as a “millimeter wave” (“mmW” or “mm Wave”). In some cases, FR2 may be further defined in terms of sub-ranges, such as a first sub-range FR2-1 including 24,250 MHz-52,600 MHz and a second sub-range FR2-2 including 52,600 MHz-71,000 MHz. A base station configured to communicate using mm Wave/near mmWave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QOS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUS) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUS 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUS 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more DUs 230 and/or one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

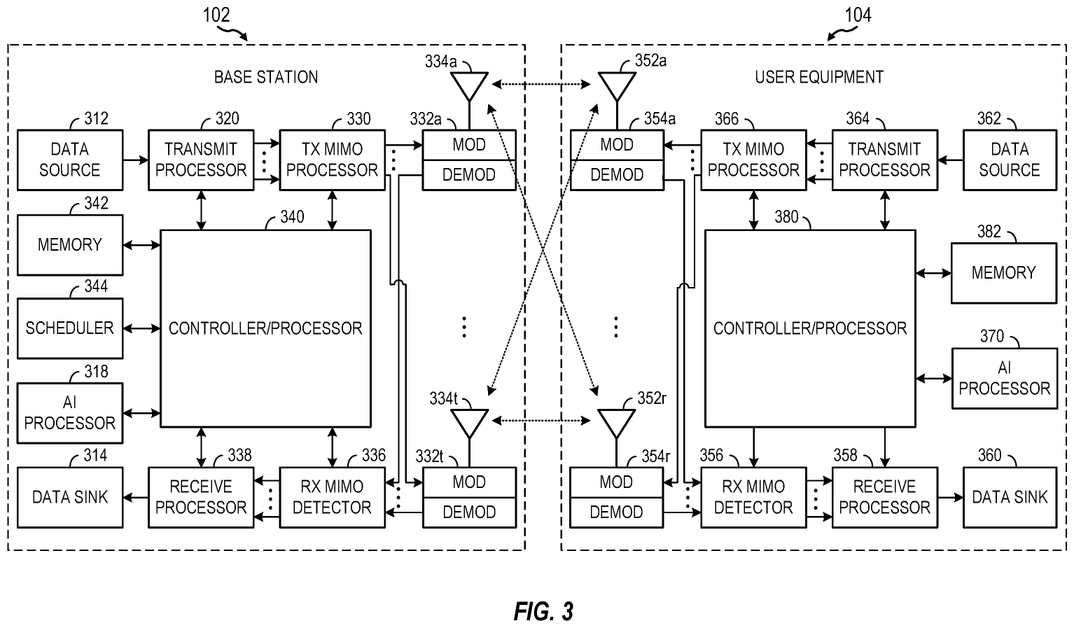

FIG. 3 depicts aspects of an example BS 102 and a UE 104.

Generally, BS 102 includes various processors (e.g., 318, 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 314). For example, BS 102 may send and receive data between BS 102 and UE 104. BS 102 includes controller/processor 340, which may be configured to implement various functions described herein related to wireless communications.

Generally, UE 104 includes various processors (e.g., 358, 364, 366, 370, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

RX MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a RX MIMO detector 336 if applicable, and further processed by a receive processor 338 to obtain decoded data and control information sent by UE 104. Receive processor 338 may provide the decoded data to a data sink 314 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

In various aspects, artificial intelligence (AI) processors 318 and 370 may perform AI processing for BS 102 and/or UE 104, respectively. The AI processor 318 may include AI accelerator hardware or circuitry such as one or more neural processing units (NPUs), one or more neural network processors, one or more tensor processors, one or more deep learning processors, etc. The AI processor 370 may likewise include AI accelerator hardware or circuitry. As an example, the AI processor 370 may perform AI-based beam management, AI-based channel state feedback (CSF), AI-based antenna tuning, and/or AI-based positioning (e.g., global navigation satellite system (GNSS) positioning). In some cases, the AI processor 318 may process feedback from the UE 104 (e.g., CSF) using hardware accelerated AI inferences and/or AI training. The AI processor 318 may decode compressed CSF from the UE 104, for example, using a hardware accelerated AI inference associated with the CSF. In certain cases, the AI processor 318 may perform certain RAN-based functions including, for example, network planning, network performance management, energy-efficient network operations, etc.

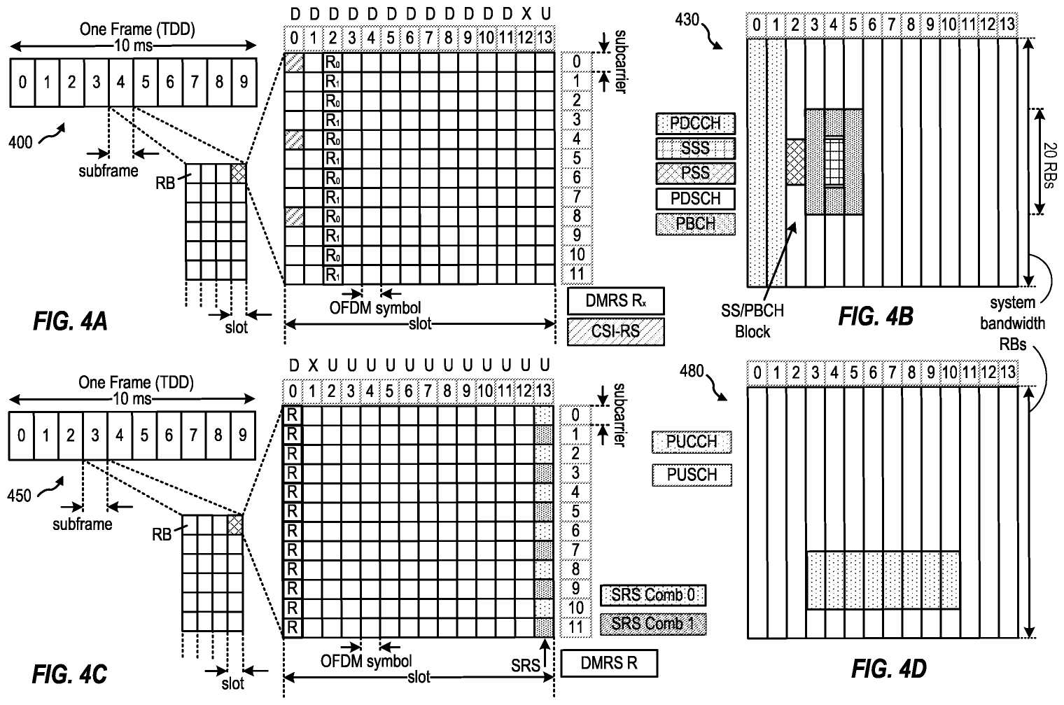

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where Dis DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 12 or 14 symbols, depending on the cyclic prefix (CP) type (e.g., 12 symbols per slot for an extended CP or 14 symbols per slot for a normal CP). Subframes may also include mini-slots, which generally have fewer symbols than an entire slot. Other wireless communications technologies may have a different frame structure and/or different channels.

In certain aspects, the number of slots within a subframe (e.g., a slot duration in a subframe) is based on a numerology, which may define a frequency domain subcarrier spacing and symbol duration as further described herein. In certain aspects, given a numerology u, there are 24 slots per subframe. Thus, numerologies (μ) 0 to 6 may allow for 1, 2, 4, 8, 16, 32, and 64 slots, respectively, per subframe. In some cases, the extended CP (e.g., 12 symbols per slot) may be used with a specific numerology, e.g., numerology 2 allowing for 4 slots per subframe. The subcarrier spacing and symbol length/duration are a function of the numerology. The subcarrier spacing may be equal to 2^{μ}×15 kHz, where u is the numerology 0 to 6. As an example, the numerology μ=0 corresponds to a subcarrier spacing of 15 kHz, and the numerology μ=6 corresponds to a subcarrier spacing of 960 kHz. The symbol length/duration is inversely related to the subcarrier spacing. FIGS. 4A, 4B, 4C, and 4D provide an example of a slot format having 14 symbols per slot (e.g., a normal CP) and a numerology μ=2 with 4 slots per subframe. In such a case, the slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme including, for example, quadrature phase shift keying (QPSK) or quadrature amplitude modulation (QAM).

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ

ACK/NACK feedback. The PUSCH carries data, and may additionally be used to carry a buffer status report (BSR), a power headroom report (PHR), and/or UCI.

### Aspects Related to PDCCH Monitoring and Adaptation

The PDCCH may carry DCI. DCI may be transmitted to one UE or a group of UEs on the PDCCH. DCI may contain (1) scheduling information for uplink and/or downlink data channels, e.g., resource assignments for uplink and/or downlink data and control information, (2) instructions related to hybrid automatic repeat request (HARQ) (e.g., a mechanism for error detection and re-transmission), (3) useful information for adjusting uplink power for power control, and/or (4) other signaling. A number of different DCI formats may be defined where each DCI format may serve a different purpose/usage, for example, scheduling of uplink data (e.g., on the physical uplink shared channel (PUSCH)) and/or downlink data (e.g., on the PDSCH). In certain aspects, a DCI format specifies an ordered set of bit fields, where each field conveys distinct transmission information, such as the frequency resource assignment for a data transmission, the time resource assignment for the data transmission, a redundancy version (RV), and/or a modulation and coding (MCS) (e.g., specifies the modulation scheme and coding rate to be used by the UE(s) for decoding downlink data).

DCI may be transmitted to a UE (e.g., via a PDCCH) using resource elements (REs) within a control resource set (CORESET) (e.g., a set of physical resources within a specific area of the downlink resource grid). A UE, intended to receive the DCI, may monitor PDCCH monitoring occasions within a search space set (SSS) that is mapped to the CORESET within which the DCI is transmitted, in order to detect and decode the DCI. For example, a UE may be configured with up to 40 SSSs, where each SSS has an index of 0-39. In certain aspects, each SSS configuration provides a UE with an SSS type (e.g., a common SSS (CSSS) or UE-specific SSS (USSS)), DCI format(s) to be monitored, and/or PDCCH monitoring occasion(s) to monitor for receiving DCI (e.g., a monitoring pattern for PDCCH monitoring occasions).

A PDCCH monitoring occasion may be a specific time interval during which a UE, such as while in a CONNECTED mode, is expected to monitor the PDCCH, such as for DCI. The frequency of PDCCH monitoring occasions for which the UE may monitor for DCI may be based on a PDCCH monitoring periodicity. Different SSS configured at the UE may have different PDCCH monitoring periodicities. For example, a PDCCH monitoring periodicity for a first SSS (e.g., belonging to a first SSSG including multiple SSSs and the first SSS) may be larger than a PDCCH monitoring periodicity for a second SSS (e.g., belonging to a second SSSG including multiple other SSSs and the second SSS) and thus include sparser PDCCH monitoring occasions (e.g., less occasions with a larger time between each occasion).

A UE may be configured to monitor one or more PDCCH monitoring occasions in one or more slots in the time-domain (e.g., based on information included in one or more SSSs configured at the UE) to decode the PDCCH in each respective slot. More specifically, with the received information included in a configured SSS at the UE, the UE may apply blind decoding (e.g., UE attempts the decoding of a set of candidates to identify if one of the candidates holds its control information) to detect corresponding DCI, which may include scheduling information for uplink and/or downlink data, in each slot. Based on receiving the DCI, the UE may have sufficient information to continue to receive and/or transmit on other channels, such as the PDSCH and/or the PUSCH.

Requiring UEs to monitor PDCCH occasions for DCI in every slot is a contributor to power consumption at the UE. As such, several power saving techniques, such as BWP-based bandwidth adaptation (e.g., PDCCH monitoring reduction, MIMO layer adaptation, secondary cell (SCell) dormancy, and cross-slot scheduling), wake-up signals (WUSs) for CONNECTED mode discontinuous reception (CDRX), and UE assistance information (UAI), were introduced. Another power saving technique includes use of a PDCCH monitoring adaptation indication as discussed herein.

In particular, a PDCCH monitoring adaptation indication may be sent to a UE, such as in a DCI, and more specifically a scheduling DCI for scheduling unicast and/or multicast data. The adaptation indication may be used to trigger PDCCH skipping and/or SSSG switching at the UE to reduce PDCCH monitoring at the UE. Power for data channel demodulation may be adjusted accordingly when transmitting the PDCCH skipping and/or the SSSG switching indication.

For example, an adaptation indication used to trigger PDCCH skipping may trigger a UE, receiving the corresponding adaptation indication, to skip (e.g., stop) monitoring one or more PDCCH monitoring occasions that the UE was previously scheduled to monitor. The one or more PDCCH monitoring occasions may occur in time during a time period, indicated by the adaptation indication, after an adaptation activation time of the adaptation indication. On the other hand, an adaptation indication used to trigger SSSG switching may trigger a UE, receiving the indication, to stop monitoring PDCCH monitoring occasions associated with a current SSSG and start monitoring PDCCH monitoring occasions associated with a target (e.g., an indicated) SSSG (e.g., switch from the current SSSG to the target SSSG after an adaptation activation time of the adaptation indication received by the UE). In some cases, such SSSG switching is used to cause the UE to monitor less PDCCH monitoring occasions by switching from an SSSG associated with denser PDCCH monitoring occasions (e.g., a larger amount of occasions with smaller periodicity) to an SSSG associated with sparser PDCCH monitoring occasions (e.g., a smaller amount of occasions with larger periodicity). As such, using either adaptation indication, a UE may monitor for less PDCCH monitoring occasions than the UE was originally scheduled to monitor, thereby reducing power consumption at the UE. Further, a UE may switch between different PDCCH monitoring efforts, to invoke power savings at different times, based on one or more adaptation indications.

As used herein, the adaptation activation time may be a starting application time (e.g., such as a definite symbol, subframe, frame, slot, etc.) for PDCCH skipping or SSSG switching triggered by the adaptation indication. In particular, after receiving signaling including the PDCCH monitoring adaptation indication, the UE may need time to process the PDCCH monitoring adaptation indication, such as time to decode the PDCCH monitoring adaptation indication and apply the PDCCH monitoring adaptation indication to change operation at the UE. As such, the adaptation activation time for the PDCCH monitoring adaptation indication may be based on a minimum amount of time needed for the UE to process the PDCCH monitoring adaptation indication after receiving the PDDCH monitoring adaptation indication. The minimum time needed to process the PDCCH monitoring adaptation may be uniform or may vary across UEs.

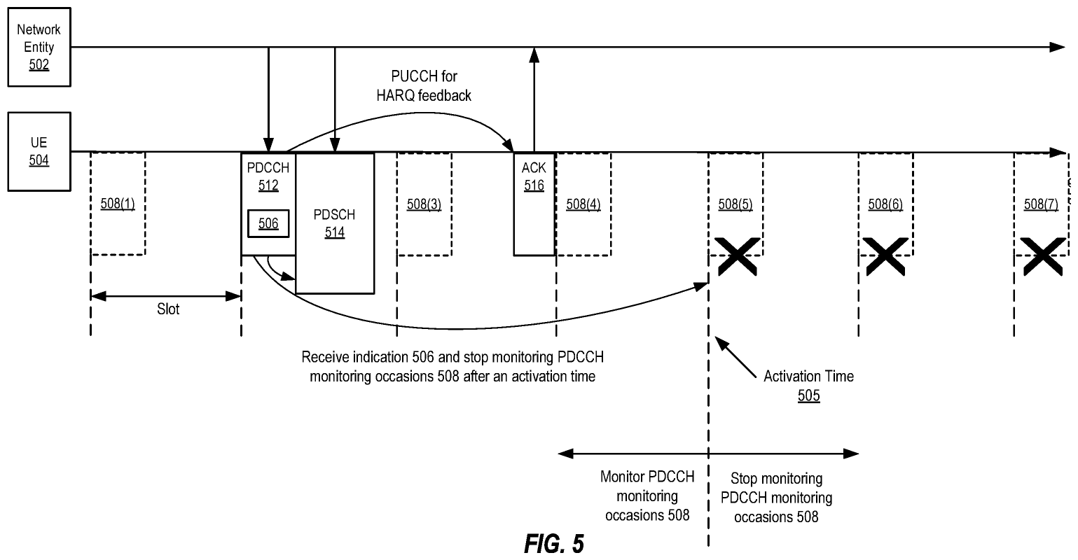

FIG. 5 depicts example PDCCH monitoring behavior of a UE adapted to stop monitoring PDCCH monitoring occasions that the UE was previously scheduled to monitor. An adaptation indication may be used to trigger the adapted behavior of the UE.

As shown in FIG. 5, a UE 504 (e.g., such as UE 104 in FIGS. 1 and 3) is configured to monitor for PDCCH in PDCCH monitoring occasions 508(1)-(7). Based on monitoring PDCCH monitoring occasion 508(2) (not shown in FIG. 5 but includes a PDCCH monitoring occasion between PDCCH monitoring occasion 508(1) and PDCCH monitoring occasion 508(3)), UE 504 receives PDCCH 512. Specifically, a network entity 502 (e.g., such as BS 102 in FIGS. 1 and 3) sends PDCCH 512, to UE 504, in PDCCH monitoring occasion 508(2). PDCCH 512 includes DCI scheduling PDSCH 514.

In this example, HARQ may be implemented to enhance the efficiency and reliability of data transmission between network entity 502 and UE 504; thus, UE 504 may be configured to transmit HARQ acknowledgement (ACK) (simply referred to herein as “ACK”) or HARQ negative acknowledgement (NACK) (simply referred to herein as “NACK”) feedback for PDSCH 514. UE 504 may transmit a NACK to request a re-transmission of the PDSCH 514 and, alternatively, an ACK when the PDSCH 514 is successfully received and decoded by UE 504. In this example, UE 504 successfully receives and decodes PDSCH 514; thus, UE 504 transmits an ACK 516.

In addition to scheduling PDSCH 514, PDCCH 512 also includes an indication 506 triggering PDCCH skipping or SSSG switching for PDCCH monitoring at UE 504. Thus, in response to receiving indication 506 and after activation time 505 of indication 506, UE 504 stops monitoring PDCCH monitoring occasions 508 (e.g., including PDCCH monitoring occasion 508(5), 508(6), 508(7), etc.), which UE 504 was previously scheduled to monitor.

In some cases, PDCCH monitoring occasions 508, which UE 504 stops monitoring, are monitoring occasions that fall within a time period after activation time 505 of indication 506, where indication 506 is a PDCCH skipping command for the time period. In some cases, PDCCH monitoring occasions 508, which UE 504 stops monitoring, are monitoring occasions that fall within a time period after activation time 505 of indication 506 and before a next DRX ON duration. Although not shown in FIG. 5, after the time period is complete, UE 504 may again begin monitoring PDCCH monitoring occasions that UE 504 is scheduled to monitor. In some other cases, PDCCH monitoring occasions 508, which UE 504 stops monitoring, are monitoring occasions associated with an SSSG previously monitored by UE 504 prior to receiving indication 506.

### Aspects Related to Overriding a PDCCH Monitoring Adaptation Indication

As described herein, adapting PDCCH monitoring behavior of a UE using, for example, a PDCCH monitoring adaptation indication, helps to reduce power consumption at a UE. For example, using either a PDCCH skipping indication or an SSSG switching indication, a UE may monitor for less PDCCH monitoring occasions than the UE was originally scheduled to monitor, thereby saving power at the UE. A UE may also switch between different PDCCH monitoring efforts, to invoke power savings at different times, based on the use of multiple adaptation indications.

Further, these PDCCH monitoring adaptation techniques may help to support new use cases, such as extended reality (XR) (including augmented reality (AR) and/or virtual reality (VR) applications). For example, an XR session may have multiple streams of high data rate traffic with short packet inter-arrival times (e.g., a mean packet arrival period of ˜16 milliseconds (ms)), and in some cases, communicated via multiple wireless communications devices (e.g., XR glasses, XR glove(s), XR controller(s), sensor(s), etc.). The XR traffic streams may include, for example, pose traffic, control traffic, sensor traffic, haptic traffic, video traffic, and/or audio traffic. PDCCH monitoring adaptation indications may be useful for such high data rate traffic types by enabling an XR device (e.g., a UE) to enter a power savings state earlier than originally expected (e.g., earlier than a next-in-time DRX OFF duration where the XR device stops monitoring for PDCCH) and reduce PDCCH monitoring for short periods of time (e.g., short sleeps) until subsequent traffic is to be received by the XR device.

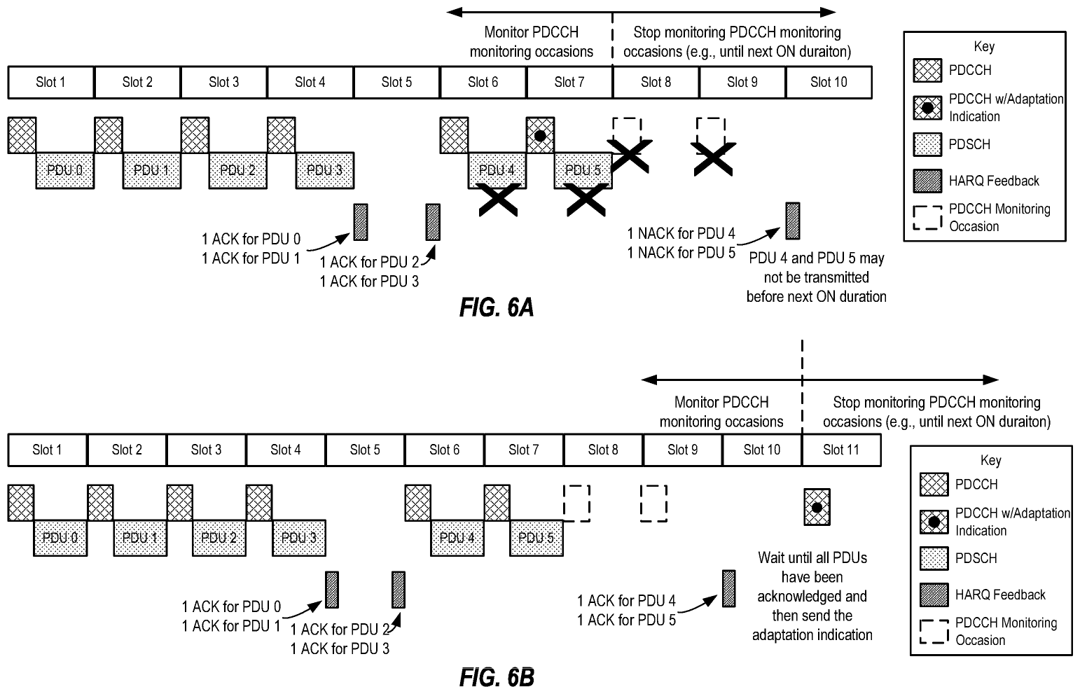

While advantageous, such power savings is often achieved at the expense of other parameter(s) of the XR session. For example, in some cases, the traffic streams of an XR session may have traffic specific QoS specifications related to latency, reliability, and/or throughput. For example, some XR traffic (e.g., pose and/or gesture traffic) may have a low latency specification (e.g., a packet delay budget of less than 10 ms, where the packet delay budget defines an upper bound for the time that a packet may be delayed between a transmitter and a receiver of the packet). As depicted in FIGS. 6A and 6B, achieving low latency, while also reducing power consumption at an XR device, may be challenging.

FIGS. 6A and 6B depict example PDCCH monitoring behavior of a UE adapted to stop monitoring PDCCH monitoring occasions that the UE was previously scheduled to monitor. In both FIGS. 6A and 6B, a PDCCH monitoring adaptation indication is used to alter the PDCCH monitoring behavior of the UE. In FIG. 6A, the PDCCH monitoring adaptation indication is transmitted to the UE earlier in time than the PDCCH monitoring adaptation indication transmitted to the UE in FIG. 6B. The earlier PDCCH monitoring adaptation indication in FIG. 6A may allow the UE to stop monitoring PDCCH monitoring occasion(s) earlier in time than the PDCCH monitoring adaptation indication in FIG. 6B to save power at the UE, although at the cost of increased latency. On the other hand, the later-in-time PDCCH monitoring adaptation indication in FIG. 6B may allow the UE to successfully receive all protocol data units (PDUs) intended for the UE prior to the UE entering a low power state (e.g., where the UE stops monitoring PDCCH monitoring occasion(s)), thereby reducing latency but at the cost of reduced power savings at the UE.

For example, in FIG. 6A, six PDUs are scheduled to be sent to a UE. PDUs 0-3 are sent to the UE in slots 1-4 based on a PDCCH scheduling the respective data transmission in each slot. In this example, the UE may receive and successfully decode PDUs 0-3. Accordingly, the UE transmits HARQ ACK feedback for PDU 0 and PDU 1 in a first uplink transmission in slot 5 and HARQ ACK feedback for PDU 2 and PDU 3 in a second uplink transmission in slot 5.

In slot 6, PDU 4 is sent to the UE. PDU 4 is scheduled by DCI included in a PDCCH also sent in slot 6. Further, in slot 7, PDU 5 is sent to the UE. PDU 5 is scheduled by DCI included in a PDCCH also sent in slot 7. In this example, the UE may not receive and/or may be unsuccessful in decoding PDU 4 and PDU 5. Accordingly, the UE transmits HARQ NACK feedback for PDU 4 and PDU 5 in a third uplink transmission in slot 10 requesting the re-transmission of PDU 4 and PDU 5.

Re-transmission of PDU 4 and PDU 5 to the UE may be delayed, however, based on a PDCCH monitoring adaptation indication being included in the PDCCH sent to the UE in slot 7 (e.g., where the PDCCH also schedules PDU 5). Specifically, the PDCCH monitoring adaptation indication indicates that the UE is to enter a low power mode and stop monitoring PDCCH monitoring occasions that the UE was previously scheduled to monitor for a specified duration. Stopping monitoring PDCCH monitoring occasions may not allow the UE to receive PDCCH scheduling re-transmission of PDU 4 and PDU 5 for at least the specified duration, and in some cases, not until a next ON duration scheduled for the UE. Accordingly, re-transmission of PDU 4 and PDU 5 may be delayed due to the transmission of the PDCCH monitoring adaptation indication (e.g., a latency hit). However, also due to the PDCCH monitoring adaptation indication, the UE may enter a low power state earlier to help save power at the UE.

Alternatively, in FIG. 6B, the UE may enter a lower power mode only after all PDUs have been received, successfully decoded, and acknowledged by the UE. For example, similar to FIG. 6A, in FIG. 6B, six PDUs are scheduled to be sent to a UE. PDUs 0-3 are sent to the UE in slots 1-4 based on a PDCCH scheduling the respective data transmission in each slot. The UE may receive and successfully decode PDUs 0-3. Thus, the UE transmits HARQ ACK feedback for PDU 0 and PDU 1 in a first uplink transmission in slot 5 and HARQ ACK feedback for PDU 2 and PDU 3 in a second uplink transmission in slot 5.

In slot 6, PDU 4 is sent to the UE. PDU 4 is scheduled by DCI included in a PDCCH also sent in slot 6. Further, in slot 7, PDU 5 is sent to the UE. PDU 5 is scheduled by DCI included in a PDCCH also sent in slot 7. In this example, the UE may receive and successfully decode PDU 4 and PDU 5. Accordingly, the UE transmits HARQ ACK feedback for PDU 4 and PDU 5 in a third uplink transmission in slot 10.

Only after receiving an ACK for all PDUs scheduled for downlink transmission to the UE may the network entity send the PDCCH monitoring adaptation indication. For example, the network entity may wait until slot 11 to send the UE a PDCCH including an adaptation indication indicating that the UE is to enter a lower power mode and stop monitoring PDCCH monitoring occasion(s) the UE was previously scheduled to monitor for a specified duration. Accordingly, in this example, transmission/re-transmission of PDUs to the UE may not be delayed due to the transmission of the PDCCH monitoring adaptation indication; however, in this example, there may be less power savings at the UE (e.g., a power hit).

As illustrated by FIGS. 6A and 6B, there may be a tradeoff between power savings at a UE and latency achieved for communications between a network entity and the UE. In some cases, it may be beneficial to use a PDCCH monitoring adaptation indication to reduce PDCCH monitoring and increase power savings at the UE. In some other cases, it may be beneficial to delay transmission of the PDCCH monitoring adaptation and/or override a previously-received PDCCH monitoring adaptation to enable the UE to monitor for PDCCH and thereby receive downlink data scheduled for the UE without delay.

Overriding a PDCCH monitoring adaptation may include monitoring for PDCCH after receiving a PDCCH monitoring adaptation indication indicating to stop monitoring one or more PDCCH monitoring occasion(s) for the PDCCH. For example, a UE that has stopped monitoring one or more PDCCH monitoring occasions that the UE was previously scheduled to monitor based on receiving a PDCCH monitoring adaptation indication triggering PDCCH skipping and/or SSSG switching, may determine to override the indication (e.g., terminate the PDCCH skipping and/or SSSG switching triggered by the adaptation indication) and again begin monitoring the PDCCH monitoring occasion(s) that the UE was previously scheduled to monitor. In cases where the PDCCH monitoring adaptation indication indicates PDCCH skipping, overriding the PDCCH monitoring adaptation indication may include re-entering a high power state to again monitor for PDCCH. In cases where the PDCCH monitoring adaptation indication indicates SSSG switching (e.g., to an SSSG associated with sparser PDCCH monitoring occasions), overriding the PDCCH monitoring adaptation indication may include monitoring PDCCH monitoring occasions associated with an SSSG that the adaptation indicated to stop monitoring (e.g., an SSSG associated with denser (e.g., more frequent) PDCCH monitoring occasions).

In some cases, a UE determines to override a previously-received PDCCH monitoring adaptation indication based on the transmission of a NACK. In particular, a UE may again begin monitoring PDCCH monitoring occasion(s) associated with an SSSG that a previously-received PDCCH monitoring adaptation indication indicated to stop monitoring. Further, a UE may terminate PDCCH skipping triggered by a previously-received PDCCH monitoring adaptation indication after transmitting a NACK. As an illustrative example, after transmitting NACK feedback in slot 10 for PDU 4 and PDU 5 in FIG. 6A discussed above, the UE may re-enter a high power mode to begin monitoring PDCCH monitoring occasion(s) the UE was indicated to stop monitoring based on the adaptation indication sent to the UE in slot 7. This may include again monitoring for PDCCH in PDCCH monitoring occasion(s) configured for slot 11, slot 12, slot 13, and/or etc. (not shown in FIG. 6A). Terminating the PDCCH skipping after transmitting a NACK may allow the UE to receive one or more data re-transmissions without delay (e.g., without having to wait until a next DRX ON duration to monitor for PDCCH scheduling the data re-transmission(s)).

In some other cases, a UE determines to override a previously-received PDCCH monitoring adaptation indication, indicating to perform PDCCH skipping, based on transmitting an SR. An SR is a physical layer message sent by the UE to the network entity to request an uplink grant to send uplink data over a PUSCH. An uplink grant may be sent to the UE, from the network entity, via a PDCCH transmission (e.g., in DCI). An uplink grant received by the UE (e.g., in DCI), in response to sending the SR, may trigger an uplink transmission by the UE.

A UE may transmit the SR to resume PDCCH monitoring (e.g., stop PDCCH skipping) when the UE has uplink data to (e.g., immediately) send to the network entity (e.g., urgent uplink data). The UE may transmit the SR to the network entity while in a low power mode and not monitoring PDCCH monitoring occasion(s) the UE was previously scheduled to monitor (e.g., based on a previously-received PDCCH monitoring adaptation indication). After sending the SR, the UE may then switch back to regular PDCCH monitoring, e.g., exit the low power mode and monitor PDCCH monitoring occasion(s) the UE was scheduled to monitor. More specifically, the UE may again begin monitoring PDCCH monitoring occasion(s) the UE was scheduled to monitor after an overriding activation time. The overriding activation time may be a starting application time (e.g., such as a definite symbol, subframe, frame, slot, etc.) for resuming PDCCH monitoring of PDCCH monitoring occasion(s) for PDCCH (e.g., including an uplink grant) triggered by the SR. As such, a UE may send an SR to terminate the PDCCH skipping triggered by the previously-received adaptation indication to reduce uplink scheduling latency that may have been increased due the inability of the UE to monitor for PDCCH and thus receive an uplink grant used to transmit uplink data from the UE to the network entity (e.g., while in a low power state and not monitoring PDCCH monitoring occasion(s)).

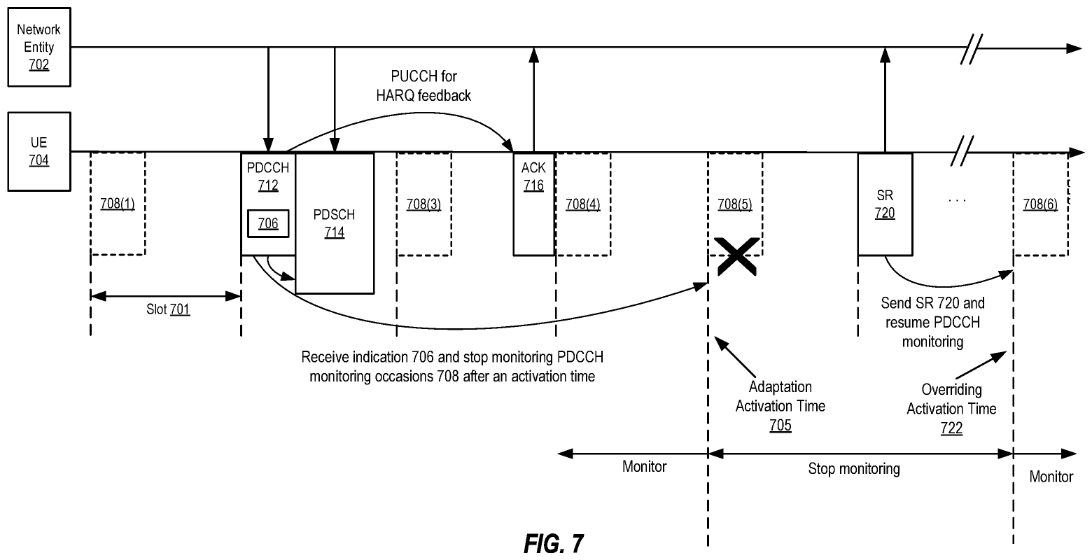

FIG. 7 depicts example adapted PDCCH monitoring behavior of a UE after sending an SR. Similar to FIG. 5, a UE 704 (e.g., such as UE 104 in FIGS. 1 and 3) is configured to monitor for PDCCH in PDCCH monitoring occasions 708(1)-(6). Based on monitoring PDCCH monitoring occasion 708(2) (not shown in FIG. 7 but includes a PDCCH monitoring occasion between PDCCH monitoring occasion 708(1) and PDCCH monitoring occasion 708(3)), UE 704 receives PDCCH 712. Specifically, a network entity 702 (e.g., such as BS 102 in FIGS. 1 and 3) sends PDCCH 712, to UE 704, in PDCCH monitoring occasion 708(2). PDCCH 712 includes DCI scheduling PDSCH 714. In this example, UE 704 successfully receives and decodes PDSCH 714; thus, UE 704 transmits an ACK 716.

In addition to scheduling PDSCH 714, PDCCH 712 also includes an indication 706 triggering, for example, PDCCH skipping for PDCCH monitoring at UE 704. Thus, in response to receiving indication 706 and after adaptation activation time 705 of indication 706, UE 704 enters a low power state and stops monitoring PDCCH monitoring occasions 708 (e.g., including PDCCH monitoring occasion 708(5), 708(6), etc.), which UE 704 was previously scheduled to monitor.

After adaptation activation time 705, however, UE 704 may determine that some uplink data is to be sent to network entity 702. To receive an uplink grant for transmitting this data, UE 704 may transmit SR 720 to network entity 702. Transmission of SR 720 to network entity 702 may trigger network entity 702 to transmit a PDCCH including the requested uplink grant. In order to receive this PDCCH including the requested uplink grant, UE 704 may again resume monitoring PDCCH monitoring occasion(s) 708. In other words, UE 704 may override the prior adaptation indication 706 indicating to stop monitoring PDCCH monitoring occasions 708, and resume with regular PDCCH monitoring. UE 704 may resume monitoring PDCCH monitoring occasion(s) (e.g., that UE 704 was instructed to stop monitoring) after an overriding activation time 722 (e.g., occurring a period of time after sending SR 720 to network entity 702). For example, in FIG. 7, UE 704 may resume monitoring for PDCCH in PDCCH monitoring occasions 708 (6) and other PDCCH monitoring occasions occurring later in time (and not shown in FIG. 7) to receive the PDCCH including the uplink grant.

Although the above description and FIG. 7 illustrate the use of an SR to override a PDCCH monitoring adaptation indication triggering PDCCH skipping, in some other cases, an SR may be used to override a PDCCH monitoring adaptation indication triggering SSSG switching. As such, after an overriding activation time (e.g., associated with the SR), the UE may again begin monitoring PDCCH monitoring occasion(s) associated with an SSSG that the UE was previously instructed to stop monitoring (e.g., via the PDCCH monitoring adaptation indication).

A technical challenge associated with using an SR to override a PDCCH monitoring adaptation indication, as shown in FIG. 7, is determining when to transmit the SR. In particular, as described above, transmitting an SR to resume PDCCH monitoring may reduce delays in communicating data between the UE and a network entity (e.g., reduce delays in receiving re-transmission(s), transmitting uplink data, etc.), yet at the cost of reduced power savings at the UE. Alternatively, following a PDCCH monitoring adaptation indication and refraining from sending an SR to override the adaptation indication, may allow for reduced power consumption at the UE but at the cost of increased latency in communications. In some cases, increased latency may be more tolerable than increased power consumption at the UE, thus it may be advantageous for the UE to stay in a low power mode and refrain from monitoring PDCCH monitoring occasion(s) for a specified duration (e.g., in accordance with the adaptation indication). In some other cases, the opposite may be true, thus it may be advantageous for the UE to monitor PDCCH monitoring occasion(s) than remain in a lower power mode (e.g., transmit an SR to override the adaptation indication). As such, a mechanism that takes such factors into consideration when triggering the termination of action(s) triggered by a previously-received PDCCH monitoring adaptation indication may be desired.

### Example Aspects Related to Adapting PDCCH Monitoring Behavior of a UE Based on a DSR

Aspects described herein provide techniques for adapting PDCCH monitoring behavior of a UE based on a DSR. For example, a DSR may be used to signal override of a PDCCH monitoring adaptation indication triggering a UE to stop monitoring one or more PDCCH monitoring occasions previously scheduled for the UE (e.g., terminate PDCCH skipping and/or SSSG switching triggered by the PDCCH monitoring adaptation indication).

As described above, a DSR is a message (e.g., MAC-CE) transmitted by a UE to provide a network entity (e.g., a BS associated with a serving cell of the UE) with a delay status for one or more LCGs, where each LCG includes one or more logical channels. The delay status for an LCG (e.g., included in the DSR) may include information about a shortest remaining time, among one or more discard timers (e.g., PDCP discard timers) associated with one or more data units buffered for the respective LCG.

For example, a QoS requirement, such as packet delay budget (simply referred to herein as “delay budget”), may be defined for communications between the UE and the network entity. The delay budget may define an upper bound for the time that a packet may be delayed when communicated between the UE and the network entity. A discard timer may be used to adhere to this delay budget requirement. For example, a value of a discard timer may be equal to the defined delay budget (e.g., discard timer value=delay budget). At least one discard timer may be associated with each LCG and may be started (e.g., begin counting down) when a first data unit for a packet (e.g., a packet may arrive at the UE as multiple PDUs) is received at the UE for a respective LCG. To meet the QoS requirement, all data units associated with the packet transmitted to the UE may need to be received at the UE prior to an expiration of the discard timer. Any data unit(s) that are received outside of this timer may be discarded, and thus may require the retransmission of all data units associated with the packet (e.g., all data units buffered at the UE may become obsolete).

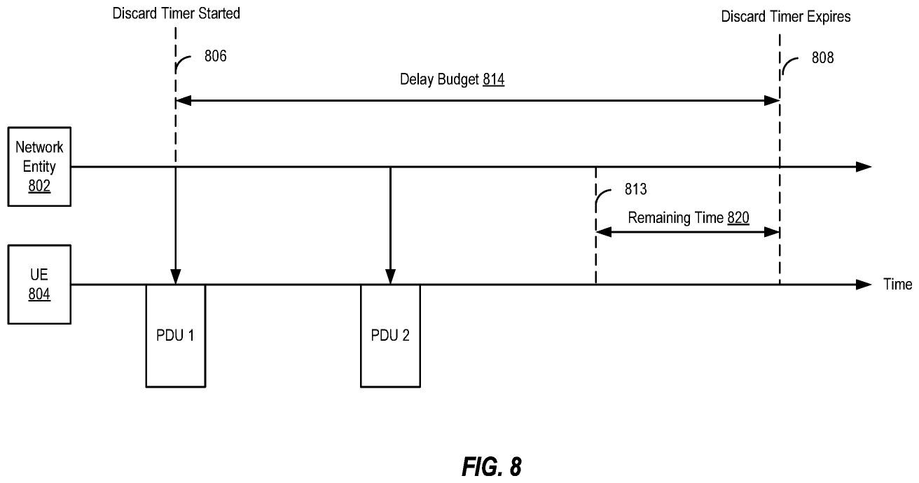

A delay status for an LCG may include information about a remaining time (e.g., a remaining delay budget) associated with a discard timer associated with data unit(s) buffered for the respective LCG. For example, as shown in FIG. 8, a delay budget 814 may be defined for a packet communicated as a plurality of data units (e.g., PDU 1, PDU 2, etc.) between a network entity 802 and a UE 804. At 806, when first data unit (e.g., PDU 1) associated with the packet is communicated between network entity 802 and UE 804, a discard timer is started. A value of the discard timer may be equal to the defined delay budget 814, such that the discard timer expires, at 808, at a time equal to delay budget 814. In this example, the packet scheduled for transmission to UE 804 may include four PDUs. At time 813, only the first PDU (e.g., PDU 1) and a second PDU (e.g., PDU 2) may have been transmitted to and buffered at UE 804. Assuming a DSR is transmitted at time 813, the DSR may include information about remaining time 820 (e.g., an amount of time remaining within delay budget 814) associated with the first PDU and the second PDU buffered at UE 804 (e.g., for the respective LCG used to transmit the first and second PDUs). UE 804 may send the DSR to network entity 802, and network entity 802 may use this information to prioritize subsequent downlink and/or uplink scheduling.

According to aspects described herein, transmission of a DSR including delay information for one or more LCGs may be used to terminate action(s) triggered by a previously-communicated PDCCH monitoring adaptation indication. For example, transmission of a DSR by a UE may allow the UE to terminate PDCCH skipping and exit a low power state to monitor at least one PDCCH monitoring occasion that the UE was previously indicated to stop monitoring. As another example, transmission of a DSR by a UE may allow the UE to terminate SSSG switching and monitor at least one PDCCH monitoring occasion that the UE associated with an SSSG that the UE was previously indicated to stop monitoring.

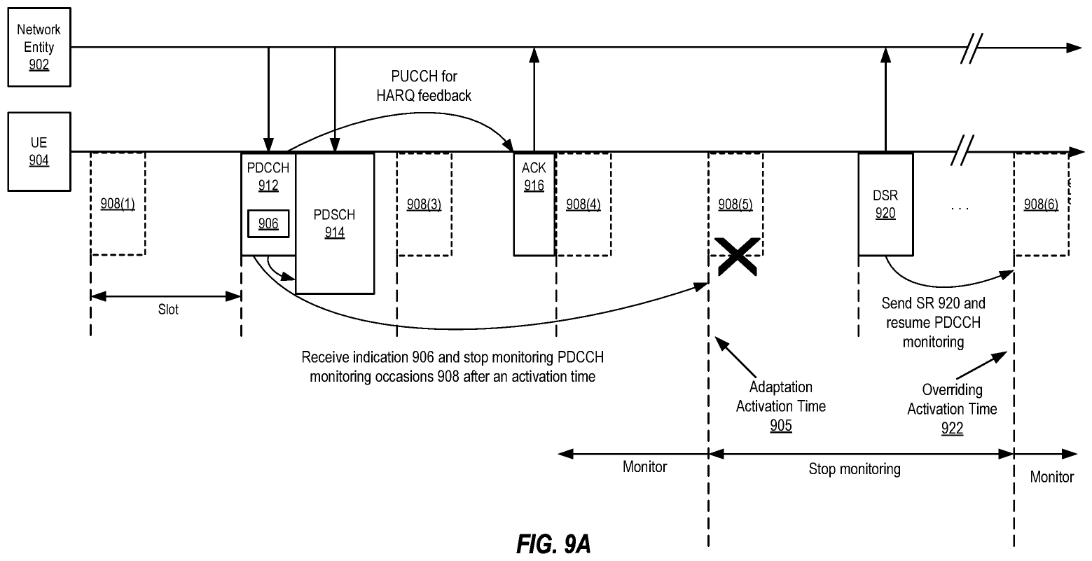

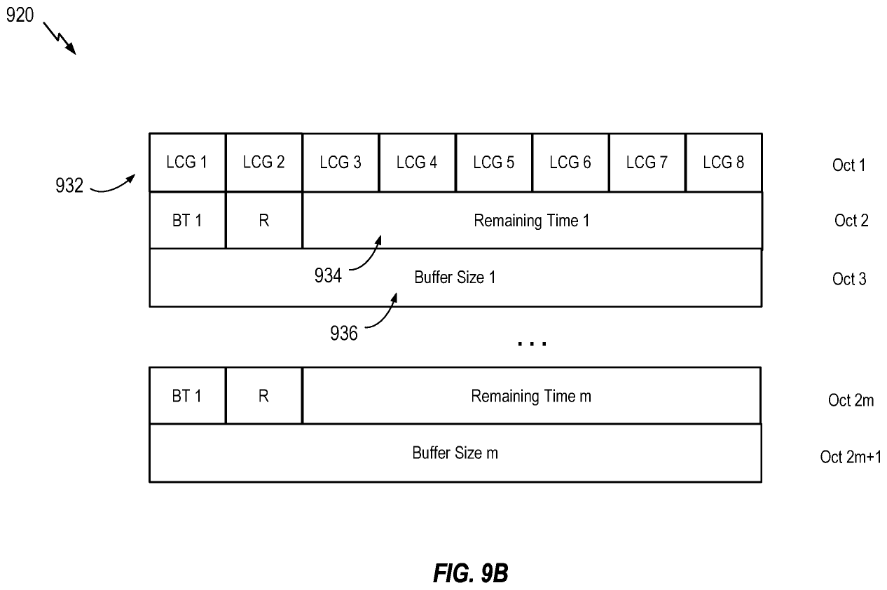

FIG. 9A depicts example adapted PDCCH monitoring behavior of a UE after sending a DSR. Similar to FIG. 7, a UE 904 (e.g., such as UE 104 in FIGS. 1 and 3) is configured to monitor for PDCCH in PDCCH monitoring occasions 908(1)-(6). Based on monitoring PDCCH monitoring occasion 908(2) (not shown in FIG. 9 but includes a PDCCH monitoring occasion between PDCCH monitoring occasion 908(1) and PDCCH monitoring occasion 908(3)), UE 904 receives PDCCH 912. Specifically, a network entity 902 (e.g., such as BS 102 in FIGS. 1 and 3) sends PDCCH 912, to UE 904, in PDCCH monitoring occasion 908 (2). PDCCH 912 includes DCI scheduling PDSCH 914. In this example, UE 904 successfully receives and decodes PDSCH 914; thus, UE 904 transmits an ACK 916.

In addition to scheduling PDSCH 914, PDCCH 912 also includes an indication 906 triggering, for example, PDCCH skipping for PDCCH monitoring at UE 904. Thus, in response to receiving indication 906 and after adaptation activation time 905 of indication 906, UE 904 enters a low power state and stops monitoring PDCCH monitoring occasions 908 (e.g., including PDCCH monitoring occasion 908 (5), 908 (6), etc.), which UE 904 was previously scheduled to monitor.

After adaptation activation time 905, however, UE 904 may send a DSR 920 to network entity 902. In certain aspects, UE 904 may send, to network entity 902, DSR 920 multiplexed in a MAC PDU.

Sending DSR 920 to UE 904 may enable UE 904 to override the prior indication 906 indicating to stop monitoring PDCCH monitoring occasions 908, and resume with regular PDCCH monitoring. For example, the DSR 920 may indicate to the network entity 902 that the UE 904 is overriding the prior indication 906. UE 904 may resume monitoring PDCCH monitoring occasion(s) (e.g., that UE 904 was instructed to stop monitoring) after an overriding activation time 922 (e.g., occurring a period of time after sending DSR 920 to network entity 902). It should be noted that in some examples, there may be no overriding activation time 922 (e.g., overriding activation time 922 is 0), such that the UE 904 immediately resumes monitoring PDCCH monitoring occasion(s) after transmission of DSR 920. For example, in FIG. 9, UE 904 may resume monitoring for PDCCH in PDCCH monitoring occasion 908(6) and other PDCCH monitoring occasions occurring later in time (and not shown in FIG. 9).

In some cases, UE 904 may resume monitoring for PDCCH in a PDCCH monitoring occasion 908 scheduled in a first slot after a last symbol of a transmission of DSR 920.

FIG. 9B depicts an example DSR, such as DSR 920 sent from UE 904 to network entity 902 in FIG. 9A. DSR 920 may include information for multiple LCGs, such as LCG 1 through LCG 8.

For example, in a first row 932 of DSR 920, an LCG field is defined for each of LCGs 1-8. The LCG field for each LCG may be set to “1” or “0.” An LCG field set to “1” indicates that delay information (e.g., remaining time information 934) and/or buffer size information 936 for the LCG is reported in DSR 920. Alternatively, an LCG field set to “0” indicates that delay information (e.g., remaining time information 934) and/or buffer size information 936 for the LCG is not included in DSR 920.

For example, if the LCG field for LCG 1 in first row 932 is set to “1,” then remaining time information and buffer size information is included for LCG 1 in DSR 920. Further, if the LCG field for LCG 2 in first row 932 is set to “0,” then remaining time information and buffer size information for LCG 2 is not included in DSR 920.

Remaining time information 934, included in DSR 920 for an LCG, includes information about a shortest remaining time, among one or more discard timers (e.g., PDCP discard timers) associated with one or more data units buffered for the respective LCG. For example, remaining time information 934 may indicate a value of remaining time 820 illustrated in FIG. 8. Buffer size information 936, included in DSR 920 for an LCG, includes information about an amount of data currently buffered for the corresponding LCG. In some cases, buffer size information 936 may include information about an amount of delay-critical uplink data buffered for the corresponding LCG. Remaining time information 934 and buffer size information 936, included in DSR for an LCG, may be reported in two consecutive octets (Oct) within DSR 920.

In certain aspects, to limit the override of a previously-received PDCCH monitoring adaptation indication based at least on transmission of a DSR, one or more conditions may be used by the UE for determining whether to override the previously-received PDCCH monitoring adaptation indication.

For example, in certain aspects, a condition is whether a discard timer associated with an LCG has a value (e.g., a remaining time of the discard time being) less than or equal to a reporting threshold (e.g., where the reporting threshold is measured from the expiration time for a discard timer). For example, a network entity may configure one or more reporting thresholds for sending DSR reporting information (e.g., such as remaining time information 934 and buffer size information 936) for an LCG when the remaining time of a discard timer associated with the LCG is less than or equal to one of the respective reporting thresholds. The one or more reporting thresholds may be measured from a starting time or an expiration time of a discard time (e.g., based on a delay budget defined for the LCG).

For example, the network entity may configure a 5 ms reporting threshold prior to the expiration of a discard timer, a 10 ms reporting threshold prior to the expiration of a discard time, and a 15 ms reporting threshold prior to the expiration of a discard timer. In this case, a UE may be configured to send a first DSR including information for one or more LCG(s) having a remaining time for one or more discard timers (e.g., associated with one or more data units buffered at the UE) less than or equal to the 15 ms reporting threshold (e.g., after starting a discard timer), send a second DSR including information for one or more LCG(s) having a remaining time for one or more discard timers (e.g., associated with one or more data units buffered at the UE) less than or equal to the 10 ms reporting threshold, and/or send a third DSR including information for one or more LCG(s) having a remaining time for one or more discard timers (e.g., associated with one or more data units buffered at the UE) less than or equal to the 5 ms reporting threshold.

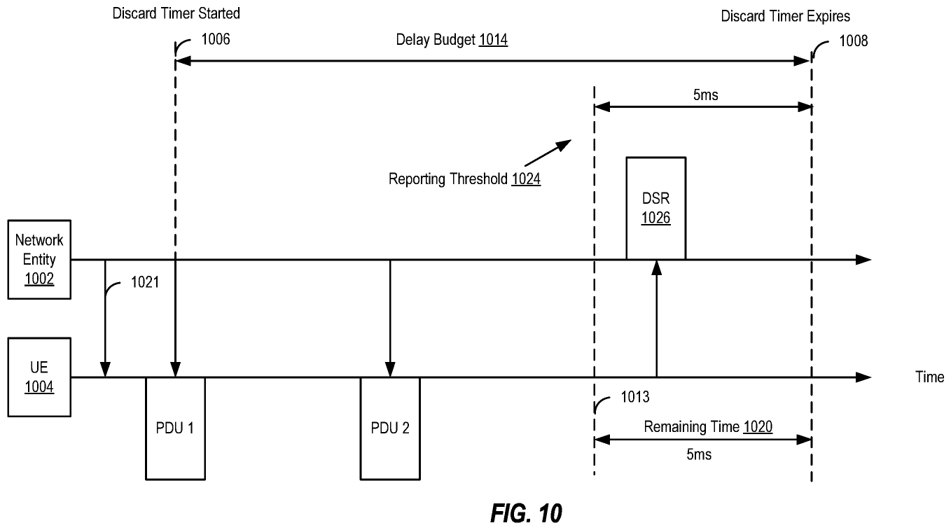

Sending a DSR, including remaining time information and buffer size information for an LCG, based on a remaining time associated with the LCG being less than a 5 ms reporting threshold configured from the expiration time of a discard timer is depicted in FIG. 10. For example, as shown, a UE 1004 receives a reporting configuration at 1021. The reporting configuration may indicate a reporting threshold for a first LCG used to communicate information and/or data between UE 1004 and a network entity 1002. In this example, the reporting threshold includes a reporting threshold 1024 occurring 5 ms prior to the expiration of a discard timer at 1006. Based on this reporting configuration, UE 1004 may be configured to send a DSR, to network entity 1002, including information for at least a first LCG based on at least one discard timer associated with the first LCG having a value (e.g., having a remaining time 1020) less than or equal to the 5 ms reporting threshold. For example, at the 5 ms reporting window occurring 5 ms prior to the expiration of the discard timer, the remaining time 1020 for the discard timer (and more specifically, delay budget 1014) may be equal to 5 ms. Because this remaining time 1020 is equal to the reporting threshold of 5 ms (e.g., measured from the expiration of the discard timer at 1008), UE 1004 may determine to send a DSR 1026 with delay information and buffer size information for the first LCG to network entity 1002.

In some cases, UE 1004 may need to wait to send DSR 1026 to network entity 1002 based on when a grant is configured for such uplink transmission. For example, in FIG. 10, UE 1004 sends DSR 1026 to network entity 1002 based on a grant configured for uplink transmission and scheduled a period of time after the configured reporting threshold. In this example, the remaining time reported for the LCG in this DSR 1026 may indicate a remaining time less than 5 ms.

In certain aspects, to limit the override of a previously-received PDCCH monitoring adaptation indication (e.g., termination of PDCCH skipping and/or SSSG switching triggered by a PDCCH monitoring adaptation), the override may be based on one or more additional conditions in addition to sending a DSR.

For example, in some cases, the one or more additional conditions include the UE having previously transmitted a NACK for one or more data units intended for the UE. For example, a network entity may send a downlink data unit to a UE via a PDSCH. The UE may fail to receive this downlink data unit and thus send NACK feedback to the network entity (e.g., as shown in FIG. 6A). Based on transmitting this NACK feedback for at least the downlink data unit transmission and transmitting a DSR, the UE may override of a previously-received PDCCH monitoring adaptation indication (e.g., terminate PDCCH skipping and/or SSSG switching). As such, the UE may resume monitoring at least one PDCCH monitoring occasion that the UE was previously indicated to stop monitoring based on transmitting the NACK and the DSR. Requiring the transmission of a DSR as well as a transmission of a NACK prior to overriding a PDCCH monitoring adaptation indication, may help to improve power consumption at a UE by only allowing the UE to resume regular PDCCH monitoring when a re-transmission is needed (e.g., to help reduce latency).

In some cases, the one or more additional conditions include the DSR sent by the UE including buffer size information for at least one LCG indicating an amount of data buffered for the at least one LCG that is greater than a threshold. For example, overriding a PDCCH monitoring adaptation indication may be based on (1) a UE sending a DSR and (2) the DSR including information about an LCG having a total amount of data units buffered greater than a threshold. Requiring such information in the DSR prior to overriding a PDCCH monitoring adaptation indication, may help to improve power consumption at a UE by only allowing the UE to resume regular PDCCH monitoring when a large amount of data for a packet intended for the UE has been received and buffered at the UE, and only a small amount of time remains to receive the remaining data unit(s) for the packet (e.g., such that the packet is transmitted within the defined delay budget).

In some cases, the one or more additional conditions include the DSR sent by the UE including information for at least one high priority LCG (e.g., an LCG having a priority greater than a threshold priority) indicating an amount of data buffered for the at least one LCG is greater than a threshold. For example, overriding a PDCCH monitoring adaptation indication may only occur for high priority LCGs. This may help to reduce power consumption at the UE by only allowing the UE to resume regular PDCCH monitoring when an LCG reported in a DSR is a high priority LCG (e.g., stay in a low power mode for low priority LCGs).

In certain aspects, the one or more additional conditions include the UE, in response to transmitting the DSR, receiving an indication from the network entity indicating to monitor at least one PDCCH monitoring occasion the UE was previously indicated to stop monitoring. For example, overriding a PDCCH monitoring adaptation indication may occur where a network entity receiving the DSR has approved the UE to terminate PDCCH skipping and/or SSSG switching, which the UE was previously indicated to perform.

### Example Aspects Related Adapting CDRX Behavior Based on a DSR

Certain aspects described herein provide techniques for adapting CDRX behavior of a UE based on a DSR. These techniques may be used in addition to or alternative to using a DSR to adapt PDCCH monitoring behavior of a UE, such as override a previously-communicated PDCCH monitoring adaptation indication indicating that the UE is to stop monitoring one or more PDCCH monitoring occasions.

For example, as described above, if CDRX is enabled for a UE, the UE, while in an RRC connected state with a network entity, may remain in a low power, sleep state (e.g., a CDRX inactive state during a DRX OFF duration, where no transmission and/or reception occurs) and only wake up periodically (e.g., transition to a CDRX active state during DRX ON durations) for a short interval of time to monitor for scheduled, downlink data. In other words, the UE may cycle through DRX ON and DRX off durations to help save power at the UE.

According to aspects described herein, while in a CDRX inactive state during a DRX OFF duration, the UE may transmit a DSR (e.g., a MAC-CE). Based on the transmission of the DSR, the UE may exit the CDRX inactive state (e.g., wake up and transition to a CDRX active state) and begin monitoring for one or more downlink transmissions (e.g., begin monitoring at least one PDCCH monitoring occasion). In certain aspects, after transitioning to the CDRX active state, the UE may start/restart a timer to receive a DCI grant used to schedule an uplink transmission.

In certain aspects, to limit the UE exiting the CDRX inactive state, the exit of the CDRX inactive state may be based on one or more additional conditions in addition to sending a DSR, such as the one or more additional conditions discussed with respect to override of a previously-received PDCCH monitoring adaptation indication.

For example, in certain aspects, a condition may include the UE receiving an indication from a network entity, in response to transmission of the DSR, indicating to exit the CDRX inactive state and begin monitoring at least one PDCCH monitoring occasion.

### Example Operations

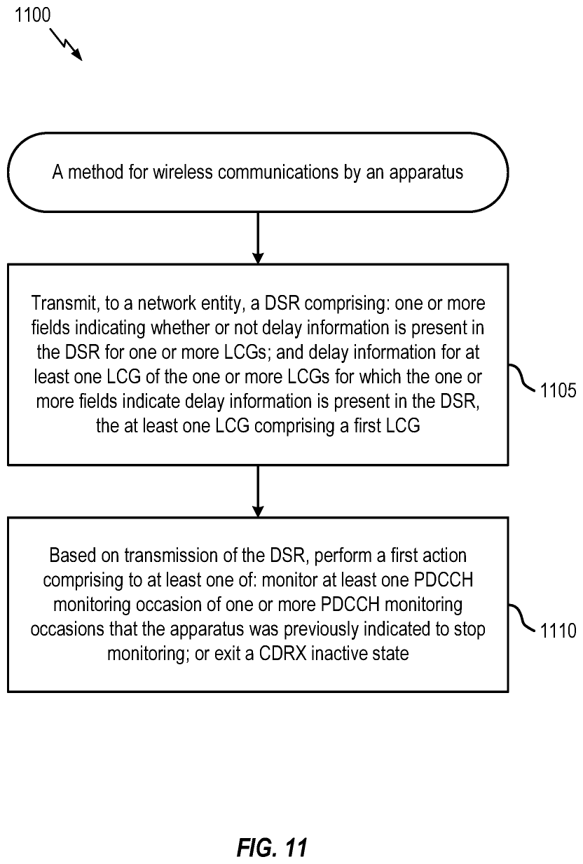

FIG. 11 shows a method 1100 for wireless communications by an apparatus, such as UE 104 of FIGS. 1 and 3.

Method 1100 begins at block 1105 with transmitting, to a network entity, a DSR comprising: one or more fields indicating whether or not delay information is present in the DSR for one or more LCGs; and delay information for at least one LCG of the one or more LCGs for which the one or more fields indicate delay information is present in the DSR, the at least one LCG comprising a first LCG.

Method 1100 then proceeds to block 1110 with, based on transmission of the DSR, performing a first action comprising to at least one of: monitor at least one PDCCH monitoring occasion of one or more PDCCH monitoring occasions that the apparatus was previously indicated to stop monitoring; or exit a CDRX inactive state.

In certain aspects, the delay information for the at least one LCG comprises first delay information for the first LCG, the first delay information comprising a first remaining time indicating a shortest remaining value among one or more discard timers associated with one or more data units buffered for the first LCG.

In certain aspects, the first delay information comprises a first buffer size indicating an amount of data buffered for the first LCG.

In certain aspects, block 1105 includes transmitting the DSR based on at least one of the one or more discard timers having a value less than or equal to a reporting threshold.

In certain aspects, the DSR is triggered based on a discard timer, associated with the first LCG, being less than or equal to a reporting threshold; each LCG of the one or more LCGs is assigned a respective priority level, including the first LCG being assigned a first priority level; and the method 1100 further comprises performing the first action based on the first priority level of the first LCG.

In certain aspects, the delay information comprises a buffer size indicating an amount of data buffered for the first LCG; and the method 1100 further comprises performing the first action based on the amount of data being greater than a threshold.

In certain aspects, the DSR is triggered based on a discard timer, associated with the first LCG, being less than or equal to a reporting threshold; and the method 1100 further comprises receiving a reporting configuration that indicates one or more reporting thresholds for the first LCG, the one or more reporting thresholds including the reporting threshold.

In certain aspects, among the one or more reporting thresholds, only the reporting threshold is associated with performance of the first action.

In certain aspects, method 1100 further includes transmitting a NACK for a previous downlink transmission.

In certain aspects, method 1100 further includes performing the first action based on transmission of the NACK.

In certain aspects, method 1100 further includes, based on transmission of the DSR, receiving, from the network entity, an indication to at least one of: monitor the at least one PDCCH monitoring occasion; or exit the CDRX inactive state. In certain aspects, method 1100 further includes, based on the indication, at least one of: monitoring the at least one PDCCH monitoring occasion; or exiting the CDRX inactive state.

In certain aspects, block 1105 includes transmitting the DSR multiplexed in a MAC PDU.

In certain aspects, the first action comprises to monitor the at least one PDCCH monitoring occasion.

In certain aspects, the at least one PDCCH monitoring occasion is scheduled in a first slot after a last symbol of transmission of the DSR.

In certain aspects, method 1100 further includes receiving, from the network entity, a PDCCH adaptation indication indicating to stop monitoring the one or more PDCCH monitoring occasions.

In certain aspects, the PDCCH adaptation indication comprises a PDCCH skipping command for a time period; and the one or more PDCCH monitoring occasions are scheduled during the time period.

In certain aspects, the PDCCH adaptation indication comprises a SSSG switching command indicating to switch from a first SSSG to a second SSSG; and the one or more PDCCH monitoring occasions are associated with the first SSSG.

In certain aspects, the first SSSG includes a first SSS; the second SSSG does not include the first SSS; and the one or more PDCCH monitoring occasions are associated with the first SSS.

In certain aspects, method 1100 further includes, based on the PDCCH adaptation indication, stopping monitoring at least one other PDCCH monitoring occasion of the one or more PDCCH monitoring occasions.

In certain aspects, the first action comprises to exit the CDRX inactive state.

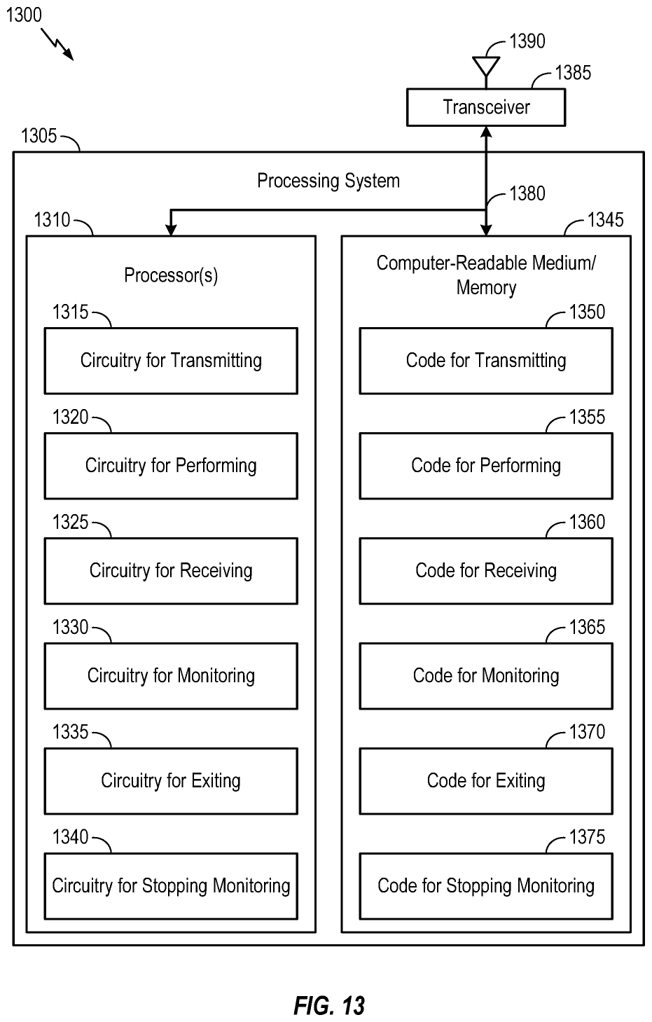

In certain aspects, method 1100, or any aspect related to it, may be performed by an apparatus, such as communications device 1300 of FIG. 13, which includes various components operable, configured, or adapted to perform the method 1100. Communications device 1300 is described below in further detail.

Note that FIG. 11 is just one example of a method, and other methods including fewer, additional, or alternative operations are possible consistent with this disclosure.

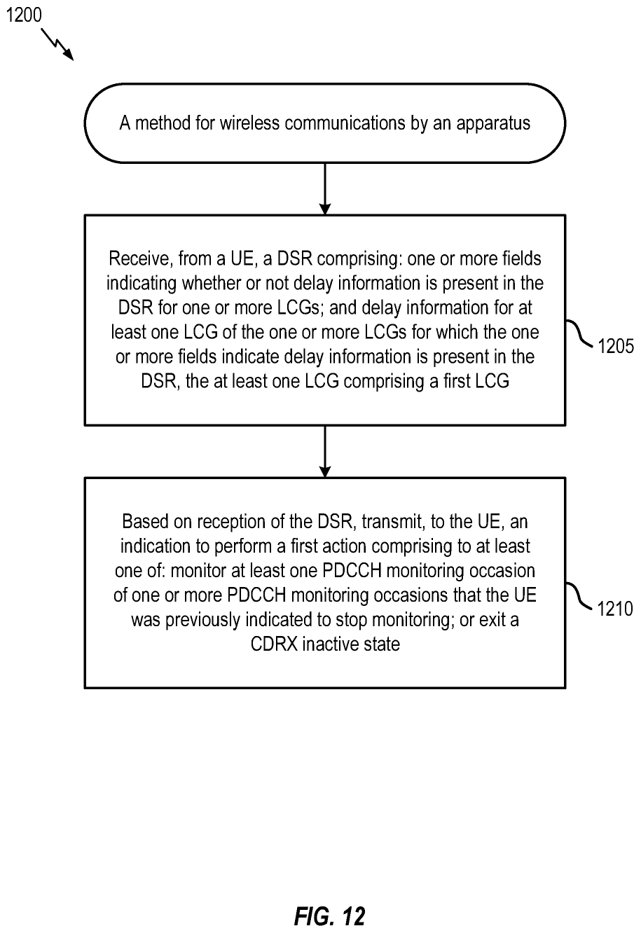

FIG. 12 shows a method 1200 for wireless communications by an apparatus, such as BS 102 of FIGS. 1 and 3, or a disaggregated base station as discussed with respect to FIG. 2.

Method 1200 begins at block 1205 with receiving, from a UE, a DSR comprising: one or more fields indicating whether or not delay information is present in the DSR for one or more LCGs; and delay information for at least one LCG of the one or more LCGs for which the one or more fields indicate delay information is present in the DSR, the at least one LCG comprising a first LCG.

Method 1200 then proceeds to block 1210 with, based on reception of the DSR, transmitting, to the UE, an indication to perform a first action comprising to at least one of: monitor at least one PDCCH monitoring occasion of one or more PDCCH monitoring occasions that the UE was previously indicated to stop monitoring; or exit a CDRX inactive state.

In certain aspects, the delay information for the at least one LCG comprises first delay information for the first LCG, the first delay information comprising a first remaining time indicating a shortest remaining value among one or more discard timers associated with one or more data units buffered for the first LCG.

In certain aspects, the first delay information comprises a first buffer size indicating an amount of data buffered for the first LCG.

In certain aspects, the DSR is triggered based on a discard timer, associated with the first LCG, being less than or equal to a reporting threshold; and the method 1200 further comprises transmitting, to the UE, a reporting configuration that indicates one or more reporting thresholds for the first LCG, the one or more reporting thresholds including the reporting threshold.

In certain aspects, block 1205 includes receiving the DSR multiplexed in a MAC PDU.

In certain aspects, the first action comprises to monitor the at least one PDCCH monitoring occasion.

In certain aspects, the at least one PDCCH monitoring occasion is scheduled in a first slot after a last symbol of transmission of the DSR.

In certain aspects, method 1200 further includes transmitting, to the UE, a PDCCH adaptation indication indicating to stop monitoring the one or more PDCCH monitoring occasions.

In certain aspects, the PDCCH adaptation indication comprises a PDCCH skipping command for a time period; and the one or more PDCCH monitoring occasions are scheduled during the time period.

In certain aspects, the PDCCH adaptation indication comprises a SSSG switching command indicating to switch from a first SSSG to a second SSSG; and the one or more PDCCH monitoring occasions are associated with the first SSSG.

In certain aspects, the first SSSG includes a first SSS; the second SSSG does not include the first SSS; and the one or more PDCCH monitoring occasions are associated with the first SSS.

In certain aspects, the first action comprises to exit the CDRX inactive state.

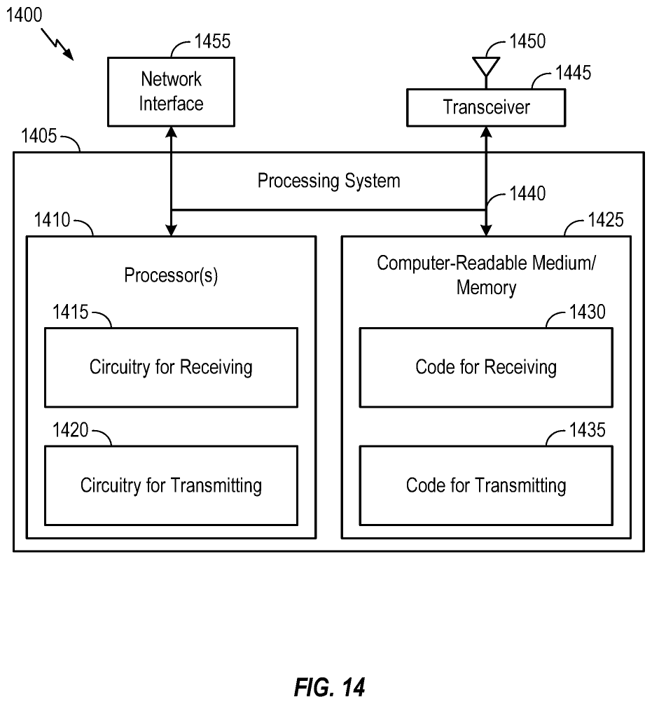

In certain aspects, method 1200, or any aspect related to it, may be performed by an apparatus, such as communications device 1400 of FIG. 14, which includes various components operable, configured, or adapted to perform the method 1200. Communications device 1400 is described below in further detail.

Note that FIG. 12 is just one example of a method, and other methods including fewer, additional, or alternative operations are possible consistent with this disclosure.

FIG. 13 depicts aspects of an example communications device 1300. In some aspects, communications device 1300 is a user equipment, such as UE 104 described above with respect to FIGS. 1 and 3.

The communications device 1300 includes a processing system 1305 coupled to a transceiver 1385 (e.g., a transmitter and/or a receiver). The transceiver 1385 is configured to transmit and receive signals for the communications device 1300 via an antenna 1390, such as the various signals as described herein. The processing system 1305 may be configured to perform processing functions for the communications device 1300, including processing signals received and/or to be transmitted by the communications device 1300.

The processing system 1305 includes one or more processors 1310. In various aspects, the one or more processors 1310 may be representative of one or more of receive processor 358, transmit processor 364, TX MIMO processor 366, and/or controller/processor 380, as described with respect to FIG. 3. The one or more processors 1310 are coupled to a computer-readable medium/memory 1345 via a bus 1380. In certain aspects, the computer-readable medium/memory 1345 is configured to store instructions (e.g., computer-executable code) that when executed by the one or more processors 1310, enable and cause the one or more processors 1310 to perform the method 1100 described with respect to FIG. 11, or any aspect related to it, including any operations described in relation to FIG. 11. Note that reference to a processor performing a function of communications device 1300 may include one or more processors performing that function of communications device 1300, such as in a distributed fashion.

In the depicted example, computer-readable medium/memory 1345 stores code for transmitting 1350, code for performing 1355, code for receiving 1360, code for monitoring 1365, code for exiting 1370, and code for stopping monitoring 1375. Processing of the code 1350-1375 may enable and cause the communications device 1300 to perform the method 1100 described with respect to FIG. 11, or any aspect related to it.

The one or more processors 1310 include circuitry configured to implement (e.g., execute) the code stored in the computer-readable medium/memory 1345, including circuitry for transmitting 1315, circuitry for performing 1320, circuitry for receiving 1325, circuitry for monitoring 1330, circuitry for exiting 1335, and circuitry for stopping monitoring 1340. Processing with circuitry 1315-1340 may enable and cause the communications device 1300 to perform the method 1100 described with respect to FIG. 11, or any aspect related to it.

More generally, means for communicating, transmitting, sending or outputting for transmission may include the transceivers 354, antenna(s) 352, transmit processor 364, TX MIMO processor 366, AI processor 370, and/or controller/processor 380 of the UE 104 illustrated in FIG. 3, transceiver 1385 and/or antenna 1390 of the communications device 1300 in FIG. 13, and/or one or more processors 1310 of the communications device 1300 in FIG. 13. Means for communicating, receiving or obtaining may include the transceivers 354, antenna(s) 352, receive processor 358, AI processor 370, and/or controller/processor 380 of the UE 104 illustrated in FIG. 3, transceiver 1385 and/or antenna 1390 of the communications device 1300 in FIG. 13, and/or one or more processors 1310 of the communications device 1300 in FIG. 13.

FIG. 14 depicts aspects of an example communications device 1400. In some aspects, communications device 1400 is a network entity, such as BS 102 of FIGS. 1 and 3, or a disaggregated base station as discussed with respect to FIG. 2.

The communications device 1400 includes a processing system 1405 coupled to a transceiver 1445 (e.g., a transmitter and/or a receiver) and/or a network interface 1455. The transceiver 1445 is configured to transmit and receive signals for the communications device 1400 via an antenna 1450, such as the various signals as described herein. The network interface 1455 is configured to obtain and send signals for the communications device 1400 via communications link(s), such as a backhaul link, midhaul link, and/or fronthaul link as described herein, such as with respect to FIG. 2. The processing system 1405 may be configured to perform processing functions for the communications device 1400, including processing signals received and/or to be transmitted by the communications device 1400.

The processing system 1405 includes one or more processors 1410. In various aspects, one or more processors 1410 may be representative of one or more of receive processor 338, transmit processor 320, TX MIMO processor 330, and/or controller/processor 340, as described with respect to FIG. 3. The one or more processors 1410 are coupled to a computer-readable medium/memory 1425 via a bus 1440. In certain aspects, the computer-readable medium/memory 1425 is configured to store instructions (e.g., computer-executable code) that when executed by the one or more processors 1410, enable and cause the one or more processors 1410 to perform the method 1200 described with respect to FIG. 12, or any aspect related to it, including any operations described in relation to FIG. 12. Note that reference to a processor of communications device 1400 performing a function may include one or more processors of communications device 1400 performing that function, such as in a distributed fashion.

In the depicted example, the computer-readable medium/memory 1425 stores code for receiving 1430 and code for transmitting 1435. Processing of the code for receiving 1430 and the code for transmitting 1435 may enable and cause the communications device 1400 to perform the method 1200 described with respect to FIG. 12, or any aspect related to it.

The one or more processors 1410 include circuitry configured to implement (e.g., execute) the code stored in the computer-readable medium/memory 1425, including circuitry for receiving 1415 and circuitry for transmitting 1420. Processing with circuitry for receiving 1415 and circuitry for transmitting 1420 may enable and cause the communications device 1400 to perform the method 1200 described with respect to FIG. 12, or any aspect related to it.

More generally, means for communicating, transmitting, sending or outputting for transmission may include the transceivers 332, antenna(s) 334, transmit processor 320, TX MIMO processor 330, AI processor 318, and/or controller/processor 340 of the BS 102 illustrated in FIG. 3, transceiver 1445, antenna 1450, and/or network interface 1455 of the communications device 1400 in FIG. 14, and/or one or more processors 1410 of the communications device 1400 in FIG. 14. Means for communicating, receiving or obtaining may include the transceivers 332, antenna(s) 334, receive processor 338, AI processor 318, and/or controller/processor 340 of the BS 102 illustrated in FIG. 3, transceiver 1445, antenna 1450, and/or network interface 1455 of the communications device 1400 in FIG. 14, and/or one or more processors 1410 of the communications device 1400 in FIG. 14.

### EXAMPLE CLAUSES

Implementation examples are described in the following numbered clauses:

Clause 1: A method for wireless communications by an apparatus comprising: transmitting, to a network entity, a DSR comprising: one or more fields indicating whether or not delay information is present in the DSR for one or more LCGs; and delay information for at least one LCG of the one or more LCGs for which the one or more fields indicate delay information is present in the DSR, the at least one LCG comprising a first LCG; and performing, based on transmission of the DSR, a first action comprising to at least one of: monitor at least one PDCCH monitoring occasion of one or more PDCCH monitoring occasions that the apparatus was previously indicated to stop monitoring; or exit a CDRX inactive state.

Clause 2: The method of Clause 1, wherein the delay information for the at least one LCG comprises first delay information for the first LCG, the first delay information comprising a first remaining time indicating a shortest remaining value among one or more discard timers associated with one or more data units buffered for the first LCG.

Clause 3: The method of Clause 2, wherein the first delay information comprises a first buffer size indicating an amount of data buffered for the first LCG.

Clause 4: The method of Clause 2, wherein transmitting the DSR comprises transmitting the DSR based on at least one of the one or more discard timers having a value less than or equal to a reporting threshold.

Clause 5: The method of any one of Clauses 1-4, wherein: the DSR is triggered based on a discard timer, associated with the first LCG, being less than or equal to a reporting threshold; each LCG of the one or more LCGs is assigned a respective priority level, including the first LCG being assigned a first priority level; and the method further comprises performing the first action based on the first priority level of the first LCG.

Clause 6: The method of any one of Clauses 1-5, wherein: the delay information comprises a buffer size indicating an amount of data buffered for the first LCG; and the method further comprises performing the first action based on the amount of data being greater than a threshold.

Clause 7: The method of any one of Clauses 1-6, wherein: the DSR is triggered based on a discard timer, associated with the first LCG, being less than or equal to a reporting threshold; and the method further comprises receiving a reporting configuration that indicates one or more reporting thresholds for the first LCG, the one or more reporting thresholds including the reporting threshold.

Clause 8: The method of Clause 7, wherein, among the one or more reporting thresholds, only the reporting threshold is associated with performance of the first action.

Clause 9: The method of any one of Clauses 1-8, further comprising: transmitting a NACK for a previous downlink transmission; and performing the first action based on transmission of the NACK.

Clause 10: The method of any one of Clauses 1-9, further comprising: based on transmission of the DSR, receiving, from the network entity, an indication to at least one of: monitor the at least one PDCCH monitoring occasion; or exit the CDRX inactive state; and based on the indication, at least one of: monitoring the at least one PDCCH monitoring occasion; or exiting the CDRX inactive state.

Clause 11: The method of any one of Clauses 1-10, wherein transmitting the DSR comprises transmitting the DSR multiplexed in a MAC PDU.

Clause 12: The method of any one of Clauses 1-11, wherein the first action comprises to monitor the at least one PDCCH monitoring occasion.

Clause 13: The method of Clause 12, wherein the at least one PDCCH monitoring occasion is scheduled in a first slot after a last symbol of transmission of the DSR.

Clause 14: The method of Clause 12, further comprising receiving, from the network entity, a PDCCH adaptation indication indicating to stop monitoring the one or more PDCCH monitoring occasions.

Clause 15: The method of Clause 14, wherein: the PDCCH adaptation indication comprises a PDCCH skipping command for a time period; and the one or more PDCCH monitoring occasions are scheduled during the time period.

Clause 16: The method of Clause 14, wherein: the PDCCH adaptation indication comprises a SSSG switching command indicating to switch from a first SSSG to a second SSSG; and the one or more PDCCH monitoring occasions are associated with the first SSSG.

Clause 17: The method of Clause 16, wherein: the first SSSG includes a first SSS; the second SSSG does not include the first SSS; and the one or more PDCCH monitoring occasions are associated with the first SSS.

Clause 18: The method of Clause 14, further comprising, based on the PDCCH adaptation indication, stopping monitoring at least one other PDCCH monitoring occasion of the one or more PDCCH monitoring occasions.

Clause 19: The method of any one of Clauses 1-18, wherein the first action comprises to exit the CDRX inactive state.

Clause 20: A method for wireless communications by an apparatus comprising: receiving, from a UE, a DSR comprising: one or more fields indicating whether or not delay information is present in the DSR for one or more LCGs; and delay information for at least one LCG of the one or more LCGs for which the one or more fields indicate delay information is present in the DSR, the at least one LCG comprising a first LCG; and based on reception of the DSR, transmitting, to the UE, an indication to perform a first action comprising to at least one of: monitor at least one PDCCH monitoring occasion of one or more PDCCH monitoring occasions that the UE was previously indicated to stop monitoring; or exit a CDRX inactive state.

Clause 21: The method of Clause 20, wherein the delay information for the at least one LCG comprises first delay information for the first LCG, the first delay information comprising a first remaining time indicating a shortest remaining value among one or more discard timers associated with one or more data units buffered for the first LCG.

Clause 22: The method of Clause 21, wherein the first delay information comprises a first buffer size indicating an amount of data buffered for the first LCG.

Clause 23: The method of any one of Clauses 20-22, wherein: the DSR is triggered based on a discard timer, associated with the first LCG, being less than or equal to a reporting threshold; and the method further comprises transmitting, to the UE, a reporting configuration that indicates one or more reporting thresholds for the first LCG, the one or more reporting thresholds including the reporting threshold.

Clause 24: The method of any one of Clauses 20-23, wherein receiving the DSR comprises receiving the DSR multiplexed in a MAC PDU.

Clause 25: The method of any one of Clauses 20-24, wherein the first action comprises to monitor the at least one PDCCH monitoring occasion.

Clause 26: The method of Clause 25, wherein the at least one PDCCH monitoring occasion is scheduled in a first slot after a last symbol of transmission of the DSR.

Clause 27: The method of Clause 25, further comprising transmitting, to the UE, a PDCCH adaptation indication indicating to stop monitoring the one or more PDCCH monitoring occasions.

Clause 28: The method of Clause 27, wherein: the PDCCH adaptation indication comprises a PDCCH skipping command for a time period; and the one or more PDCCH monitoring occasions are scheduled during the time period.

Clause 29: The method of Clause 27, wherein: the PDCCH adaptation indication comprises a SSSG switching command indicating to switch from a first SSSG to a second SSSG; and the one or more PDCCH monitoring occasions are associated with the first SSSG.

Clause 30: The method of Clause 29, wherein: the first SSSG includes a first SSS; the second SSSG does not include the first SSS; and the one or more PDCCH monitoring occasions are associated with the first SSS.

Clause 31: The method of any one of Clauses 20-30, wherein the first action comprises to exit the CDRX inactive state.

Clause 32: One or more apparatuses, comprising: one or more memories comprising executable instructions; and one or more processors configured to execute the executable instructions and cause the one or more apparatuses to perform a method in accordance with any one of Clauses 1-31.

Clause 33: One or more apparatuses, comprising: one or more memories; and one or more processors, coupled to the one or more memories, configured to cause the one or more apparatuses to perform a method in accordance with any one of Clauses 1-31.

Clause 34: One or more apparatuses, comprising: one or more memories; and one or more processors, coupled to the one or more memories, configured to perform a method in accordance with any one of Clauses 1-31.

Clause 35: One or more apparatuses, comprising means for performing a method in accordance with any one of Clauses 1-31.

Clause 36: One or more non-transitory computer-readable media comprising executable instructions that, when executed by one or more processors of one or more apparatuses, cause the one or more apparatuses to perform a method in accordance with any one of Clauses 1-31.

Clause 37: One or more computer program products embodied on one or more computer-readable storage media comprising code for performing a method in accordance with any one of Clauses 1-31.

Clause 38: A user equipment (UE), comprising: a processing system that includes processor circuitry and memory circuitry that stores code and is coupled with the processor circuitry, the processing system configured to cause the UE to perform a method in accordance with any one of Clauses 1-31.

Clause 39: A network entity, comprising: a processing system that includes processor circuitry and memory circuitry that stores code and is coupled with the processor circuitry, the processing system configured to cause the network entity to perform a method in accordance with any one of Clauses 1-31.

### ADDITIONAL CONSIDERATIONS

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “a controller,” “a memory,” “a transceiver,” “an antenna,” “the processor,” “the controller,” “the memory,” “the transceiver,” “the antenna,” etc.), unless otherwise specifically stated, should be understood to refer to one or more elements (e.g., “one or more processors,” “one or more controllers,” “one or more memories,” “one more transceivers,” etc.). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus configured for wireless communications, comprising:
one or more memories comprising processor-executable instructions; and
one or more processors configured to execute the processor-executable instructions and cause the apparatus to:
transmit, to a network entity, a delay status report (DSR) comprising:
one or more fields indicating whether or not delay information is present in the DSR for one or more logical channel groups (LCGs); and
delay information for at least one LCG of the one or more LCGs for which the one or more fields indicate delay information is present in the DSR, the at least one LCG comprising a first LCG; and
based on transmission of the DSR, perform a first action comprising to at least one of:
monitor at least one physical downlink control channel (PDCCH) monitoring occasion of one or more PDCCH monitoring occasions that the apparatus was previously indicated to stop monitoring; or
exit a connected mode discontinuous reception (CDRX) inactive state.

2. The apparatus of claim 1, wherein the delay information for the at least one LCG comprises first delay information for the first LCG, the first delay information comprising a first remaining time indicating a shortest remaining value among one or more discard timers associated with one or more data units buffered for the first LCG.

3. The apparatus of claim 2, wherein the first delay information comprises a first buffer size indicating an amount of data buffered for the first LCG.

4. The apparatus of claim 2, wherein to transmit the DSR, the one or more processors are configured to execute the processor-executable instructions and cause the apparatus to:
transmit the DSR based on at least one of the one or more discard timers having a value less than or equal to a reporting threshold.

5. The apparatus of claim 1, wherein:
the DSR is triggered based on a discard timer, associated with the first LCG, being less than or equal to a reporting threshold;
each LCG of the one or more LCGs is assigned a respective priority level, including the first LCG being assigned a first priority level; and
the one or more processors are configured to execute the processor-executable instructions and cause the apparatus to perform the first action based on the first priority level of the first LCG.

6. The apparatus of claim 1, wherein:
the delay information comprises a buffer size indicating an amount of data buffered for the first LCG; and
the one or more processors are configured to execute the processor-executable instructions and cause the apparatus to perform the first action based on the amount of data being greater than a threshold.

7. The apparatus of claim 1, wherein:
the DSR is triggered based on a discard timer, associated with the first LCG, being less than or equal to a reporting threshold; and
the one or more processors are configured to execute the processor-executable instructions and cause the apparatus to receive a reporting configuration that indicates one or more reporting thresholds for the first LCG, the one or more reporting thresholds including the reporting threshold.

8. The apparatus of claim 7, wherein, among the one or more reporting thresholds, only the reporting threshold is associated with performance of the first action.

9. The apparatus of claim 1, wherein:
the one or more processors are configured to execute the processor-executable instructions and cause the apparatus to transmit a negative acknowledgement (NACK) for a previous downlink transmission; and
the one or more processors are configured to execute the processor-executable instructions and cause the apparatus to perform the first action based on transmission of the NACK.

10. The apparatus of claim 1, wherein the one or more processors are configured to execute the processor-executable instructions and cause the apparatus to:
based on transmission of the DSR, receive, from the network entity, an indication to at least one of:
monitor the at least one PDCCH monitoring occasion; or
exit the CDRX inactive state; and
based on the indication, at least one of:
monitor the at least one PDCCH monitoring occasion; or
exit the CDRX inactive state.

11. The apparatus of claim 1, wherein to transmit the DSR, the one or more processors are configured to execute the processor-executable instructions and cause the apparatus to transmit the DSR multiplexed in a medium access control (MAC) protocol data unit (PDU).

12. The apparatus of claim 1, wherein the first action comprises to monitor the at least one PDCCH monitoring occasion.

13. The apparatus of claim 12, wherein the at least one PDCCH monitoring occasion is scheduled in a first slot after a last symbol of transmission of the DSR.

14. The apparatus of claim 12, wherein the one or more processors are configured to execute the processor-executable instructions and cause the apparatus to receive, from the network entity, a PDCCH adaptation indication indicating to stop monitoring the one or more PDCCH monitoring occasions.

15. The apparatus of claim 14, wherein:
the PDCCH adaptation indication comprises a PDCCH skipping command for a time period; and
the one or more PDCCH monitoring occasions are scheduled during the time period.

16. The apparatus of claim 14, wherein:
the PDCCH adaptation indication comprises a search space set group (SSSG) switching command indicating to switch from a first SSSG to a second SSSG; and
the one or more PDCCH monitoring occasions are associated with the first SSSG.

17. The apparatus of claim 16, wherein:
the first SSSG includes a first search space set (SSS);
the second SSSG does not include the first SSS; and
the one or more PDCCH monitoring occasions are associated with the first SSS.

18. The apparatus of claim 14, wherein the one or more processors are configured to execute the processor-executable instructions and cause the apparatus to, based on the PDCCH adaptation indication, stop monitoring at least one other PDCCH monitoring occasion of the one or more PDCCH monitoring occasions.

19. The apparatus of claim 1, wherein the first action comprises to exit the CDRX inactive state.

20. An apparatus configured for wireless communications, comprising:
one or more memories comprising processor-executable instructions; and
one or more processors configured to execute the processor-executable instructions and cause the apparatus to:
receive, from a user equipment (UE), a delay status report (DSR) comprising:
one or more fields indicating whether or not delay information is present in the DSR for one or more logical channel groups (LCGs); and
delay information for at least one LCG of the one or more LCGs for which the one or more fields indicate delay information is present in the DSR, the at least one LCG comprising a first LCG; and
based on reception of the DSR, transmit, to the UE, an indication to perform a first action comprising to at least one of:
monitor at least one physical downlink control channel (PDCCH) monitoring occasion of one or more PDCCH monitoring occasions that the UE was previously indicated to stop monitoring; or
exit a connected mode discontinuous reception (CDRX) inactive state.

21. The apparatus of claim 20, wherein the delay information for the at least one LCG comprises first delay information for the first LCG, the first delay information comprising a first remaining time indicating a shortest remaining value among one or more discard timers associated with one or more data units buffered for the first LCG.

22. The apparatus of claim 21, wherein the first delay information comprises a first buffer size indicating an amount of data buffered for the first LCG.

23. The apparatus of claim 20, wherein:
the DSR is triggered based on a discard timer, associated with the first LCG, being less than or equal to a reporting threshold; and
the one or more processors are configured to execute the processor-executable instructions and cause the apparatus to transmit, to the UE, a reporting configuration that indicates one or more reporting thresholds for the first LCG, the one or more reporting thresholds including the reporting threshold.

24. The apparatus of claim 20, wherein to receive the DSR, the one or more processors are configured to execute the processor-executable instructions and cause the apparatus to receive the DSR multiplexed in a medium access control (MAC) protocol data unit (PDU).

25. The apparatus of claim 20, wherein the first action comprises to monitor the at least one PDCCH monitoring occasion.

26. The apparatus of claim 25, wherein the at least one PDCCH monitoring occasion is scheduled in a first slot after a last symbol of transmission of the DSR.

27. The apparatus of claim 25, wherein the one or more processors are configured to execute the processor-executable instructions and cause the apparatus to transmit, to the UE, a PDCCH adaptation indication indicating to stop monitoring the one or more PDCCH monitoring occasions.

28. The apparatus of claim 27, wherein:
the PDCCH adaptation indication comprises a PDCCH skipping command for a time period; and
the one or more PDCCH monitoring occasions are scheduled during the time period.

29. A method for wireless communications by an apparatus comprising:
transmitting, to a network entity, a delay status report (DSR) comprising:
one or more fields indicating whether or not delay information is present in the DSR for one or more logical channel groups (LCGs); and
delay information for at least one LCG of the one or more LCGs for which the one or more fields indicate delay information is present in the DSR, the at least one LCG comprising a first LCG; and
based on transmission of the DSR, perform a first action comprising to at least one of:
monitor at least one physical downlink control channel (PDCCH) monitoring occasion of one or more PDCCH monitoring occasions that the apparatus was previously indicated to stop monitoring; or
exit a connected mode discontinuous reception (CDRX) inactive state.

30. A method for wireless communications by an apparatus comprising:
receiving, from a user equipment (UE), a delay status report (DSR) comprising:
one or more fields indicating whether or not delay information is present in the DSR for one or more logical channel groups (LCGs); and
delay information for at least one LCG of the one or more LCGs for which the one or more fields indicate delay information is present in the DSR, the at least one LCG comprising a first LCG; and
based on reception of the DSR, transmitting, to the UE, an indication to perform a first action comprising to at least one of:
monitor at least one physical downlink control channel (PDCCH) monitoring occasion of one or more PDCCH monitoring occasions that the UE was previously indicated to stop monitoring; or
exit a connected mode discontinuous reception (CDRX) inactive state.
